(19) United States
(12) Patent Application Publication
(10) Pub. No.: US 2011/0047528 A1
(43) Pub. Date: Feb. 24, 2011

(54) SOFTWARE TOOL FOR WRITING SOFTWARE FOR ONLINE QUALIFICATION MANAGEMENT

(75) Inventors: Paul Blanchard, Montreal (CA); Luc Chevalier, Montreal (CA); Pierre Blanchard, Montreal (CA)

Correspondence Address: OSLER, HOSKIN & HARCOURT LLP (Iscopia), 1000 DE LA GAUCHETIERE STREET WEST, SUITE 2100, MONTREAL, QC, H3B 4W5, CA

(73) Assignee: ISCOPIA SOFTWARE INC., Montreal, QC (CA)

(21) Appl. No.: 12/446,042

(22) PCT Filed: Oct. 16, 2007
(86) PCT No.: PCT/CA2007/001853

§ 371 Date: Apr. 17, 2009

Related U.S. Application Data
(60) Provisional application No. 60/862,034, filed on Oct. 18, 2006.
(60) Provisional application No. 60/885,842, filed on Jan. 19, 2007.

(51) Int. Cl. G06F 9/44

(52) U.S. Cl. 717/113

(57) ABSTRACT

An online qualification management system that can be used to perform qualification management, such as candidate assessment for recruiting or promoting purposes, job description simulations, and learning management. A computing entity can execute a software application to implement a qualification management project that interacts online with a candidate to perform an assessment procedure on the candidate. The qualification management project includes a set of modules intended to interact individually with the candidate being assessed. One of the modules of the set may be a test module for testing the candidate for one or more skills. Another one of the modules of the set may be a virtual simulation module and implement a virtual simulation, the virtual simulation having a scenario defined by a chain of events and including a plurality of graphical scenes. The virtual simulation can also involve one or more avatars and/or interactive graphical objects. An author can use an authoring tool to create the qualification management project.

### CROSS-REFERENCE TO RELATED APPLICATIONS

This application claims priority from: U.S. Provisional Patent Application No. 60/862,034 filed on Oct. 18, 2006 and incorporated by reference herein; and U.S. Provisional Patent Application No. 60/885,842 filed on Jan. 19, 2007 and incorporated by reference herein.

### FIELD OF THE INVENTION

The present invention relates to online tools to perform qualification management, such as candidate assessment for recruiting or promoting purposes, job description, and learning management. More particularly, the invention relates to online qualification management systems, authoring tools to produce online qualification management systems, methods to produce online qualification management systems, and methods to perform qualification management via online systems.

### BACKGROUND

Qualification management, such as candidate assessment for recruiting or promoting purposes, job description, and learning management, conventionally involved interviewing, lecturing, or otherwise talking to individuals as well as possibly subjecting them to written tests or other exercises.

More recently, certain aspects of qualification management have been facilitated by computer networking technology such as the Internet. For example, employers or recruiters can post openings online and candidates can apply online for these openings.

However, there remains a need for further improvements harnessing computer networking technology to facilitate various aspects of qualification management, in particular to develop online qualification management systems tailored to different qualification management needs.

### SUMMARY OF THE INVENTION

As embodied and broadly described herein, the invention provides a computer having a display and a user input device for interacting with a user. The computer executes software for implementing an authoring tool user interface for allowing the user to create a software application executable by a computing entity to implement a qualification management project including a set of modules intended to interact individually with a candidate being assessed by the qualification management project. The authoring tool user interface includes a first control allowing the user to select at least some of the modules of the set of modules from a library of modules.

The invention also provides a method implemented on a computer having a display and a user input device for interacting with a user. The method comprises: implementing an authoring tool user interface for allowing the user to create a software application executable by a computing entity to implement a qualification management project including a set of modules intended to interact individually with a candidate being assessed by the qualification management project; and providing the authoring tool user interface with a first control allowing the user to select at least some of the modules of the set of modules from a library of modules.

The invention also provides a computer having a display and a user input device for interacting with a user. The computer executes software for implementing an authoring tool user interface for allowing the user to create a software application executable by a computing entity to implement a qualification management project including a set of modules intended to interact individually with a candidate being assessed by the qualification management project. One of the modules of the set is a virtual simulation module and implements a virtual simulation, the virtual simulation having a scenario defined by a chain of events and including a plurality of graphical scenes.

The invention also provides a computer readable storage medium containing program code for execution by a computing entity to implement an authoring tool, the authoring tool allowing a user to create a software application executable to implement a qualification management project including a set of modules intended to interact individually with a candidate being assessed by the qualification management project. The program code comprises a component to implement an authoring tool user interface that includes a first control allowing the user to select at least some of the modules of the set of modules from a library of modules.

The invention also provides a computer readable storage medium containing program code for execution by a computing entity to implement an authoring tool, the authoring tool allowing a user to create a software application executable to implement a qualification management project including a set of modules intended to interact individually with a candidate being assessed by the qualification management project. One of the modules of the set is a virtual simulation module and implements a virtual simulation, the virtual simulation having a scenario defined by a chain of events and including a plurality of graphical scenes. The program code comprises a component to implement an authoring tool user interface.

The invention also provides a computer having a display and a user input device for interacting with a candidate. The computer is responsive to signals sent from a computing entity at a remote location over a data network for implementing a user interface of a qualification management project for assessing the candidate, the qualification management project including a set of modules intended to interact individually with the candidate via the user interface. The computer executes software to: sense candidate inputs at the user input device; generate signals conveying information describing the candidate inputs; send the signals conveying the information describing the candidate inputs to the computing entity at the remote location over the data network, the computing entity including logic rules which determine a sequence in which modules from the set of modules will interact with the candidate, the logic rules using as a factor the candidate inputs in determining the sequence. The computer is responsive to signals from the computing entity sent over the data network to allow the candidate to interact with the modules according to the determined sequence.

The invention also provides a computer having a display and a user input device for interacting with a candidate. The computer is responsive to signals sent from a computing entity at a remote location over a data network for implementing a user interface of a qualification management project for assessing the candidate, the qualification management project including a set of modules intended to interact individually with the candidate via the user interface, one of the modules of the set being a virtual simulation module and implementing a virtual simulation, the virtual simulation having a scenario defined by a chain of events and including a plurality of graphical scenes, the virtual simulation involving one or more interactive graphical objects. The computer executes software to: generate signals conveying information describing interactions of the candidate with the one or more interactive graphical objects; send the signals conveying the information describing interactions of the candidate with the one or more interactive graphical objects to the computing entity at the remote location over the data network, the computing entity implementing logic rules which determine a sequence in which events of the scenario occur as the virtual simulation is being run by using as a factor the interactions of the candidate with the one or more interactive graphical objects. The computer is responsive to signals from the computing entity sent over the data network to allow the events of the scenario to occur according to the determined sequence.

The invention also provides a computer having a display and a user input device for interacting with a candidate. The computer is responsive to signals sent from a computing entity at a remote location over a data network for implementing a user interface of a qualification management project for assessing the candidate, the qualification management project including a set of modules intended to interact individually with the candidate via the user interface, one of the modules of the set being a virtual simulation module and implementing a virtual simulation, the virtual simulation having a scenario defined by a chain of events and including a plurality of graphical scenes.

The invention also provides a computer readable storage medium containing program code for execution by a computing entity to implement a qualification management project that interacts online with a candidate to perform an assessment procedure on the candidate. The program code comprises: a component for implementing a user interface to communicate information to the candidate being assessed by the qualification management project and to receive candidate inputs; a component for implementing a set of modules intended to interact individually with the candidate; and a component for processing inputs made by the candidate during interaction with one or more modules of the set of modules and determining at least in part on the basis of the inputs a sequence according to which the interaction with the candidate with modules of the set of modules is to continue.

The invention also provides a computer readable storage medium containing program code for execution by a computing entity to implement a qualification management project that interacts online with a candidate to perform an assessment procedure on the candidate. The program code comprises: a component for implementing a user interface to communicate information to the candidate being assessed by the qualification management project and to receive candidate inputs; a component for implementing a set of modules intended to interact individually with the candidate; one a of the modules of the set being a virtual simulation module and implementing a virtual simulation, the virtual simulation having a scenario defined by a chain of events and including a plurality of graphical scenes, the virtual simulation including an interactive graphical object with which the candidate can interact; and a component for processing inputs made by the candidate during interaction with the interactive graphical object and determining at least in part on the basis of the inputs a sequence in which events of the scenario occur as the virtual simulation is being run.

The invention also provides a computer readable storage medium containing program code for execution by a computing entity to implement a qualification management project that interacts online with a candidate to perform an assessment procedure on the candidate. The program code comprises: a component for implementing a user interface to communicate information to the candidate being assessed by the qualification management project and to receive candidate inputs; and a component for implementing a set of modules intended to interact individually with the candidate, one of the modules of the set being a virtual simulation module and implementing a virtual simulation, the virtual simulation having a scenario defined by a chain of events and including a plurality of graphical scenes.

These and other aspects of the invention will become apparent to those of ordinary skill in the art upon review of the following description of embodiments of the invention in conjunction with the accompanying drawings.

### BRIEF DESCRIPTION OF THE DRAWINGS

A detailed description of non-limiting embodiments of the invention is provided hereinbelow with reference to the following drawings, in which:

FIG. 1 shows an example of an architecture providing an online qualification management system for performing qualification management in accordance with a non-limiting embodiment of the invention, wherein the architecture comprises a client computer operable to interact with a qualification management system server over a data network;

FIG. 2 shows an example of components enabling interaction between the client computer and the qualification management system server;

FIG. 3 shows an example of an architecture to develop a qualification management project, wherein the qualification management system server implements an authoring tool to create a qualification management project;

FIG. 4 shows an example of implementation of the authoring tool and an example of implementation of a qualification management project produced by the authoring tool;

FIG. 5 shows an example of implementation of components of the authoring tool;

FIGS. 6 to 38 show different example manifestations of a graphical user interface (GUI) of the authoring tool;

FIG. 39 is a representation of an event tree generator of the authoring tool;

FIGS. 40 to 42 illustrate a flow chart depicting an example of interaction of a candidate with the qualification management system server over the data network;

FIG. 43 shows an example of a window presenting a login page to the candidate;

FIG. 44 shows an example of a window presenting a consent form to the candidate;

FIG. 45 shows an example of a window prompting the candidate to provide personal information; and

FIGS. 46 to 53 show examples of windows presenting a virtual simulation to the candidate.

In the drawings, embodiments of the invention are illustrated by way of example. It is to be expressly understood that the description and drawings are only for purposes of illustration and as an aid to understanding. They are not intended to be a definition of the limits of the invention.

### DETAILED DESCRIPTION OF NON-LIMITING EMBODIMENTS

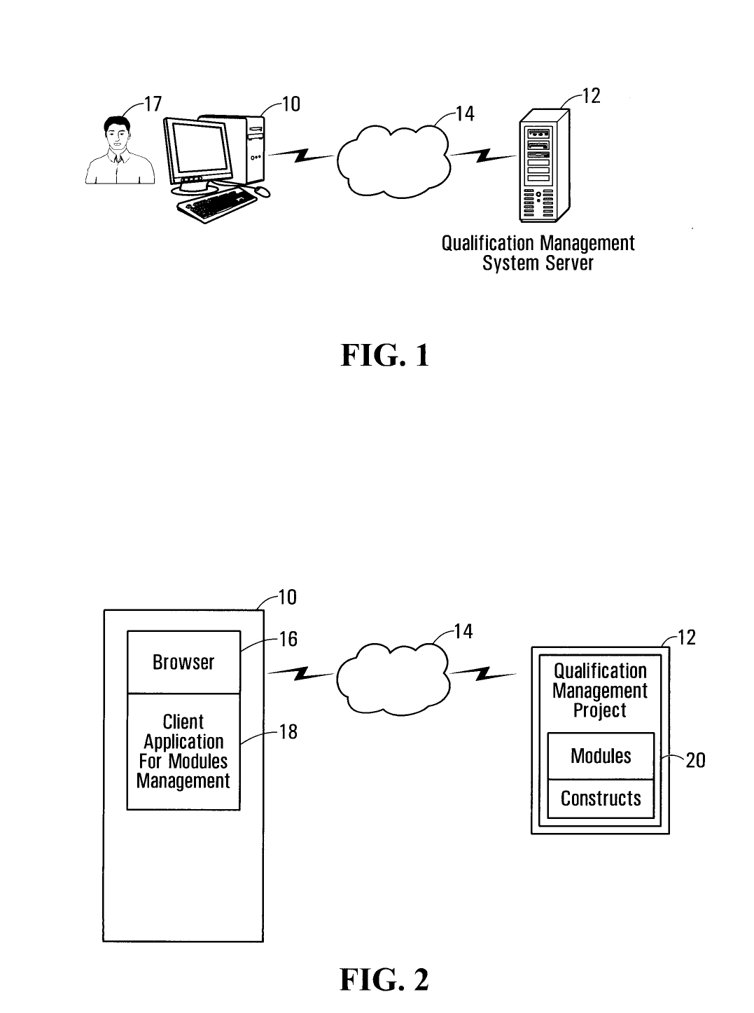

FIG. 1 shows an example of an architecture providing an online qualification management system for performing qualification management, in particular assess a person's suitability for a certain job, in accordance with a non-limiting embodiment of the invention. The architecture comprises a computing entity, in this case a qualification management system server 12, connected to a data network 14 and implementing a data network site accessible via the data network 14. In this example, the data network 14 is the Internet and the data network site is a website. Although shown as being one element, the qualification management system server 12 may be implemented by one or more computers (e.g., a server farm or other group of networked computers) forming a computing entity.

A candidate 17 for a job can use a client computer 10 to interact with the qualification management system server 12 over the Internet 14. The client computer 10 may comprise a computing entity; a display, a speaker, and possibly one or more other output devices; and one or more input devices such as a keyboard, a mouse, a microphone, a stylus, and/or a touchscreen. The computing entity may be implemented by a combination of hardware and software. In various embodiments, the client computer 10 may be a personal computer (e.g., a desktop or laptop computer) or a workstation, or it may be a networked personal digital assistant (PDA) or other wireless communication device having access to the data network 14 and having computing functionality.

As further discussed below, the candidate 17 can use the client computer 10 to access the website implemented by the qualification management system server 12, log on to the website by providing identification information (e.g., a special code or personal information such as, for example, his/her name, date of birth, email address) and authentication information (e.g., a password).

The candidate 17 may be expected to complete a consent form and may be prompted (e.g., by being asked a series of questions) to provide personal information such as his/her name, contact information (e.g., telephone number, email address, home address), education (e.g., degrees obtained, schools attended), work experience, work restrictions (e.g., authorization to work in a certain country), or other personal information.

The candidate 17 may then be presented with one or more positions (jobs) in an organization and may be allowed to optionally view job descriptions of these one or more positions. Each job description may be presented in the form of a text document and/or a virtual simulation in order to give the candidate 17 a more realistic idea of the corresponding position.

Upon selecting a particular one of the one or more positions, the candidate 17 may be asked to complete an online qualification assessment task, which would help further assess his/her suitability for the selected position. Assuming the candidate 17 decides to take the assessment task, he/she is presented with a series of text-based tests and/or interactive virtual simulations. An interactive virtual simulation is designed to present information, such as one or more questions or situations, to measure or assess certain predefined qualities of the candidate 17. With each interactive virtual simulation, the candidate 17 is given an opportunity to choose an answer or a course of action in response to each of one or more questions or situations that arises.

The qualification management system server 12 provides a scoring function to record the candidate's interaction and response to each text-based test and/or interactive virtual simulation and produce a report on the candidate's performance.

On completion of the assessment task, the qualification management system server 12 may send to the candidate 17 or another party (e.g., a recruiter or potential employer) an email acknowledging completion of the assessment and optionally the result given by the scoring function or a report based on it.

FIG. 2 is a block diagram illustrating an example of implementation of components enabling interaction between the client computer 10 and the qualification management system server 12. Generally, interaction between the client computer 10 and the qualification management system server 12 can be effected via an exchange of signals over the Internet 14 (e.g., signals generated by the qualification management system server 12 to allow the client computer 10 to implement a user interface for interacting with the candidate 17; signals generated by the client computer 10 that convey information describing inputs made by the candidate 17 using the one or more input devices of the client computer 10; etc.).

In this embodiment, the client computer 10 implements an Internet browser 16 that includes integrally or as a plug-in a client application 18 for managing different modules that constitute building blocks of the qualification management system. The client application 18 can be Adobe (MacroMedia) Flash Player or any other suitable one.

The qualification management system server 12 implements at least one qualification management project 20 with which the client computer 10 interacts. A qualification management project 20 can be associated with a given job (position) type. Therefore, there may be as many qualification management projects as there are job types for which openings exist. Examples of job types include: sales clerk, security guard, store manager, secretary, file clerk, among many others, all of which may be associated with different qualification management projects.

As further described later on, in this embodiment, a qualification management project 20 includes a set of modules and a set of constructs. Typically, the modules convey information (graphical and/or textual) to the candidate 17 and can receive information from the candidate 17 as he/she interacts with the qualification management project 20. An example of a module is a text-based assessment test that the candidate 17 is asked to complete. Another example of a module is a virtual simulation that provides a description of the job associated with the qualification management project 20 or that interacts with the candidate 17 for assessment purposes. Many other different modules can be used. The set of constructs defines a logic of the qualification management project 20, such as a sequence in which the candidate 17 will individually interact with the different modules. The set of constructs also takes into account the manner in which the candidate 17 interacts with the qualification management project 20. For instance, actions performed by the candidate 17 during a virtual simulation or answers provided by the candidate 17 as part of a text-based assessment test will condition subsequent interaction with the qualification management project 20.

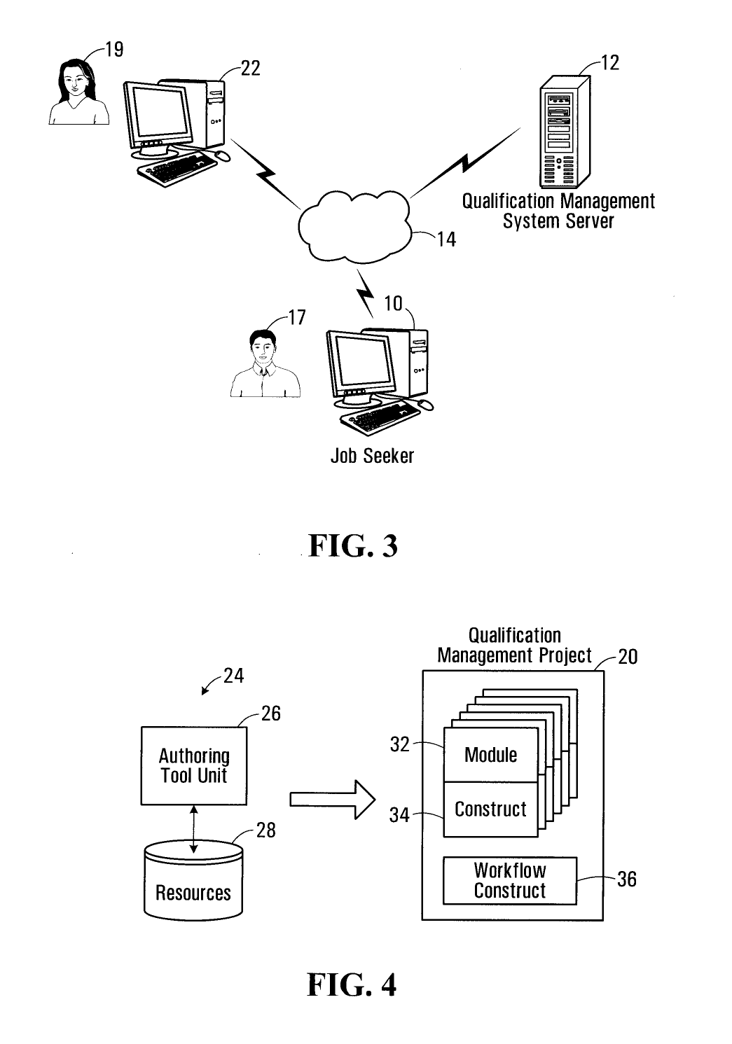

FIG. 3 is block diagram illustrating an architecture that can be used to develop a qualification management project 20. An author 19 of one or more qualification management projects 20 can use a client computer 22 to interact with the qualification management system server 12 over the Internet 14. The client computer 22 may comprise a computing entity; a display, a speaker, and possibly one or more other output devices; and one or more input devices such as a keyboard, a mouse, a microphone, a stylus, and/or a touchscreen. The computing entity may be implemented by a combination of hardware and software. In various embodiments, the client computer 22 may be a personal computer (e.g., a desktop or laptop computer) or a workstation, or it may be a networked personal digital assistant (PDA) or other wireless communication device having access to the data network 14 and having computing functionality.

In this embodiment, in addition to implementing the one or more qualification management projects 20, the qualification management system server 12 also implements an authoring tool that allows the author 19 to create one or more qualification management projects 20. In this example, the authoring tool and the qualification management projects 20 reside on the same server 12. Therefore, as the author 19 is working with the authoring tool to produce a qualification management project 20, candidates (such as the candidate 17) can use client computers (such as the client computer 10) to interact with respective qualification management projects 20 on the same server 12. Note that, in other examples, it is equally well feasible to run on different servers the qualification management projects 20 and the authoring tool to create qualification management projects 20.

FIG. 4 is a block diagram illustrating an example of implementation of the authoring tool and an example of implementation of a qualification management project 20 produced by the authoring tool. The authoring tool, which is designated generally by 24, includes a software-implemented authoring tool unit 26 designed to interact via the Internet 14 with the author 19 at the client computer 22, such as to remotely receive commands and cause display on the client computer 22 of information for the author 19 to see. The authoring tool unit 26 communicates with a resources library 28. The resources library 28 may be implemented on the same platform on which the authoring tool unit 26 resides or on a different platform. For instance, the resources library 28 may be implemented by a different server that is physically remote from the qualification management server 12 but communicates with it over the Internet 14.

In this example, a qualification management project 20 that is produced by the authoring tool 24 includes a set of modules 32. Each module 32 is associated with one or more constructs 34 (in this case, a single construct). The qualification management project 20 also includes a workflow construct 36.

Any one of the modules 32 is a component of the qualification management project 20 with which the candidate 17 can interact. By “interact” is meant that the candidate 17 will obtain some type of information from the module 32 and optionally will input some information into that module 32. An example of a module 32 that requires no input from the candidate 17 is a message (e.g., a welcoming message) displayed on the display of the client computer 10. Another example of a module 32 that requires no input from the candidate 17 is an email sent to the candidate 17 confirming his/her participation in and completion of the online assessment. An example of a module 32 that requires information input from the candidate 17 is a consent form, on which the candidate 17 must expressly indicate his/her acceptance or refusal of conditions related to his/her participation to the assessment. Another example of a module 32 that requires information input from the candidate 17 is a multiple choice test where the candidate 17 must answer questions. Yet another and more complex example of a module 32 that requires information input from the candidate 17 is an interactive virtual simulation in which the candidate 17 must perform one or more actions and/or answer one or more questions.

Each module 32 contains program code that defines how that module 32 behaves when executed, in particular one or more functions performed by that module 32 when executed. Examples of functions that can be performed by a module 32 when executed include:
Causing the information contained in the module 32 (e.g., a message type module) to be shown to the candidate 17, and detecting when the candidate 17 has finished viewing it (e.g., by sensing clicking of a close button).
Tracking actions of the candidate 17 while the candidate 17 interacts with the module 32. A simple example of tracking is determining the answers provided by the candidate 17 to questions in a test. In this example, the program code monitors which answers are provided to individual questions and stores these answers in memory (e.g., in a table). Other examples of tracking of actions will be discussed later in the context of a virtual simulation example.
Processing information input by the candidate 17 as he/she interacts with the module 32.
Causing dispatch of an email to the candidate 17. In this example, the program code contains instructions to trigger the dispatch of the email and determine when this dispatch has been completed.

It will be appreciated that these functions are presented for example purposes and that various other functions may be performed by a module 32 when executed, depending on its nature.

It will also be appreciated that for simple modules, such as those designed simply to communicate information to the candidate 17, the program code of these modules may be quite simple, while for more complex modules 32, such as those where information is sought from the candidate 17, more complex program code may be required.

Each construct 34 associated with a module 32 contains program code to perform one or more operations upon completion of execution of the module 32. An example of an operation performed upon completion of execution of a module 32 is indicating to the workflow construct 36 that execution of the module 32 is completed. Such operation may be performed, for instance, in the case of a message type module 32 that has presented its information to the candidate 17 and has detected that the candidate 17 has finished viewing this information, or in the case of an equal employment opportunity (EEO) form module that has detected that the candidate 17 as provided all required personal information about himself/herself. Another example of an operation performed upon completion of execution of a module 32 is scoring or marking the performance of the candidate 17 in relation to that module 32. In this example, the program code contained in a construct 34 associated with the module 32 implements a scoring or marking function (algorithm) to generate a score of the candidate's performance based on interaction of the candidate 17 with the module 32. For instance, in the case of a module 32 implementing a text-based test, the scoring function computes a score on a basis of answers provided by the candidate 17 in responses to questions of the test. The scoring function may have multiple layers, in the sense that the same questionnaire may be used to evaluate the candidate 17 for different personality traits, such as for example, sociability, aggressiveness, etc.

The workflow construct 36 of the qualification management project 20 defines the workflow of the project 20. Specifically, the workflow construct 36 selectively invokes the modules 32 and determines an order in which the modules 32 will be run, makes decisions as to whether certain modules 32 will be run or will not be run, including decisions on branching operations. In a branching operation, the workflow construct 34 makes a decision about an action to be carried out on a basis of characteristics of the candidate 17 or on a basis of a manner in which the candidate 17 has interacted with the qualification management project 20. An example of a branching operation is a situation where the candidate is a female and the workflow construct 36 will take a workflow branch specifically designed for females. Another example of a branching operation is a situation where the candidate 17 scores so poorly at initial tests that there is no sense to continue the assessment. Therefore, on the basis of scores, the workflow construct 36 will terminate the assessment and will not invoke any subsequent tests.

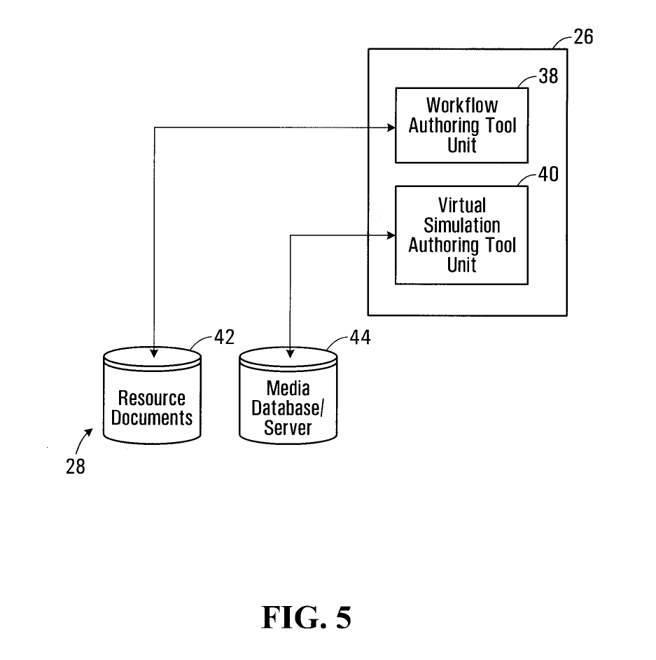

A more detailed block diagram of the authoring tool unit 26 and of the resources library 28 is shown in FIG. 5. In this embodiment, the authoring tool unit 26 has two main components, namely a workflow automation unit 38 and a virtual simulation authoring tool unit 40.

The workflow automation unit 38 is used for generating all the modules 32 and associated constructs 34, except modules 32 that provide a virtual simulation to the candidate 17. The workflow automation module 38 communicates with a library 42 of resource documents that are used for building the modules 32. Specifically, the author 19 at the client computer 22 can access the library 42 and select among the documents and resources available to build one or more of the modules 32. Examples of resource documents that can reside in the library 42 include, a set of different messages (e.g., welcoming messages), a set of different consent forms, a set of different windows to capture biographic or other personal information about a candidate (such as the candidate 17), a set of different text-based tests, a set of different confirmation emails, etc. In addition to providing a wide variety of resource documents the author 19 can chose from, those resource documents can be specifically tailored to meet specific conditions or criteria. For instance, the resource documents may be organized and tailored on a country basis, for use in qualification management projects 20 that will be implemented in different countries, where employment laws require or prohibit certain practices. Another possible form of classification is language, where the resource documents are grouped per language of the candidate 17.

The virtual simulation authoring tool unit 40 is used to generate modules 32 providing a virtual simulation to the candidate 17. The virtual simulation authoring tool unit 40 communicates with a media database/server 44 that provides media services during the building of a virtual simulation.

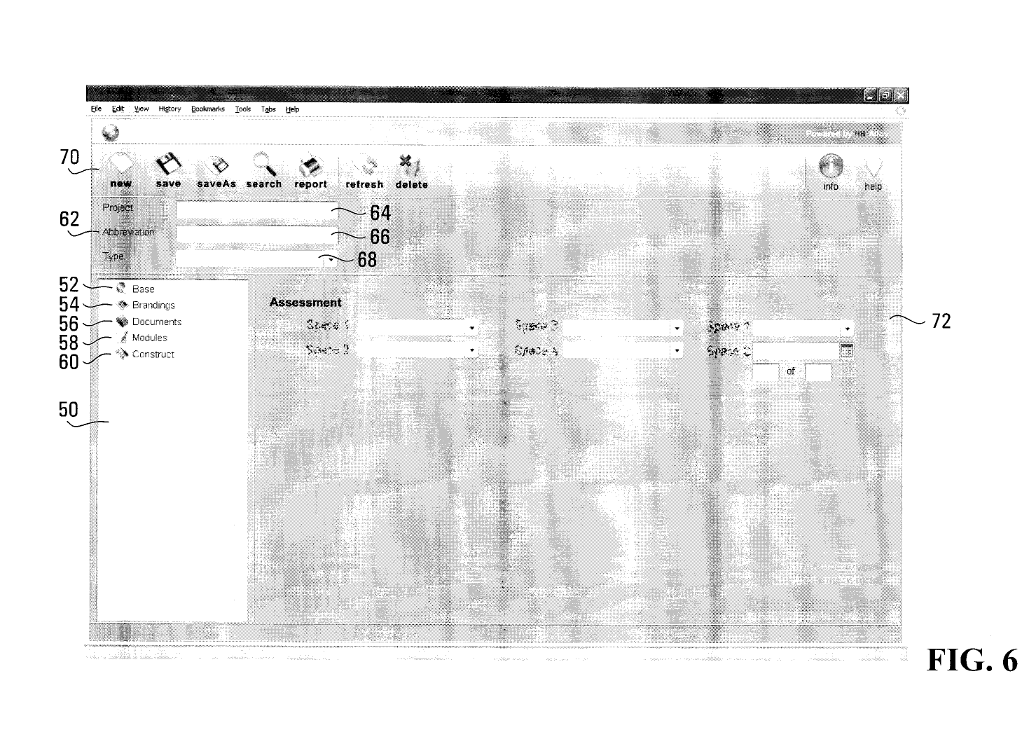

An example of operation of the workflow automation module 38 will now be discussed with reference to FIGS. 6 to 14. These figures show different example manifestations, in this case windows, of a graphical user interface (GUI) of the workflow automation module 38 that allow the author 19 to input commands using any suitable input device of the client computer 22, such as a keyboard, a mouse, a microphone, a stylus, a touchscreen, or another input device.

FIG. 6 shows a window that the author 19 can see at the beginning of creation of a qualification management project 20. The window has an area 50 with a list of selectable elements, such as a Base element 52, a Branding element 54, a Documents element 56, a Modules element 58, and a Construct element 60. By selecting any one of these elements, the author 19 is directed to an appropriate window. The window shown in FIG. 6 corresponds to the Base element 52. Above the area 50 is provided an area 62 with input fields 64, 66 and 68 where the author 19 can input a name of the project 20, an abbreviation thereof, and a type of the project 20. Above the area 62 are located a series of buttons 70 that correspond to typical commands, such as New, Save, SaveAs, Search, Report, Refresh, and Delete. On the right of the area 50 is provided an area 72 that contains additional fields in which the author 19 may be input other information about the project 20, such as its priority, whether it is active or not, its date of expiration, hiring authority, among others.

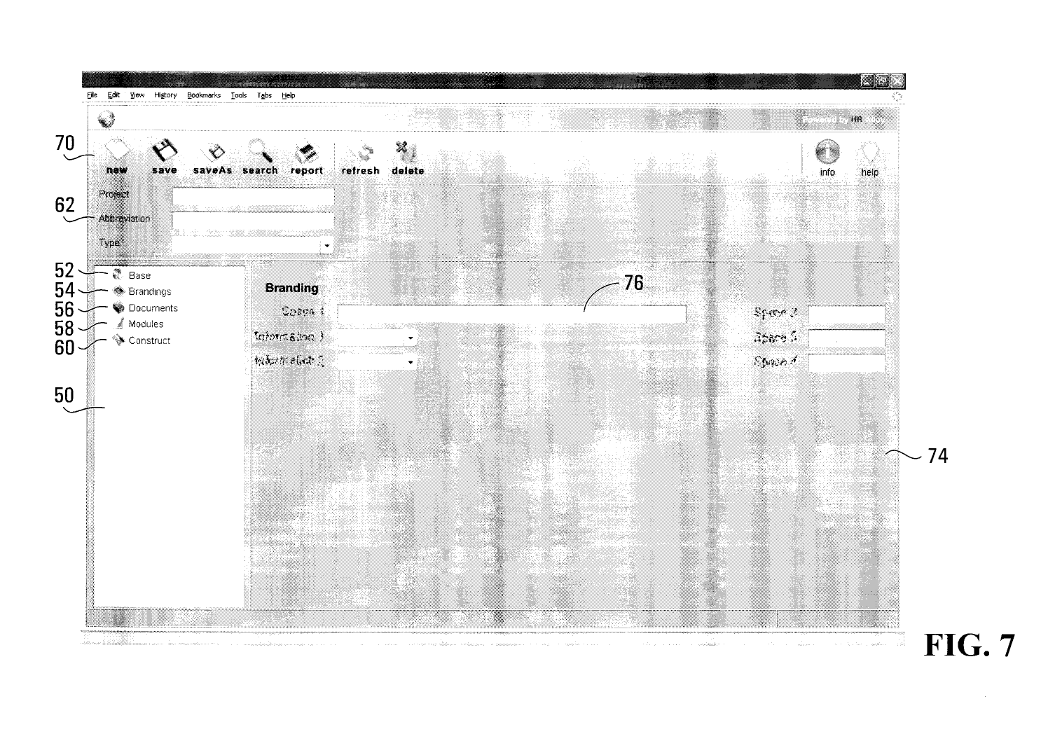

A selection of the Branding element 54 will direct the author 19 to the window shown in FIG. 7. Note that the area 50, the buttons 70 and the area 62 are the same as the previous window. An area 74 contains various fields 76 allowing the author 19 to import graphical material that can be used in designing pages or documents that candidates (such as the candidate 17) will see when they are being assessed. For instance, the graphical material can include a logo of a company that is looking to fill a position. The fields 76 allow specifying a graphical background to use and a frame, if any. The fields 76 also allow specifying any top or bottom logos to use and frames, if any.

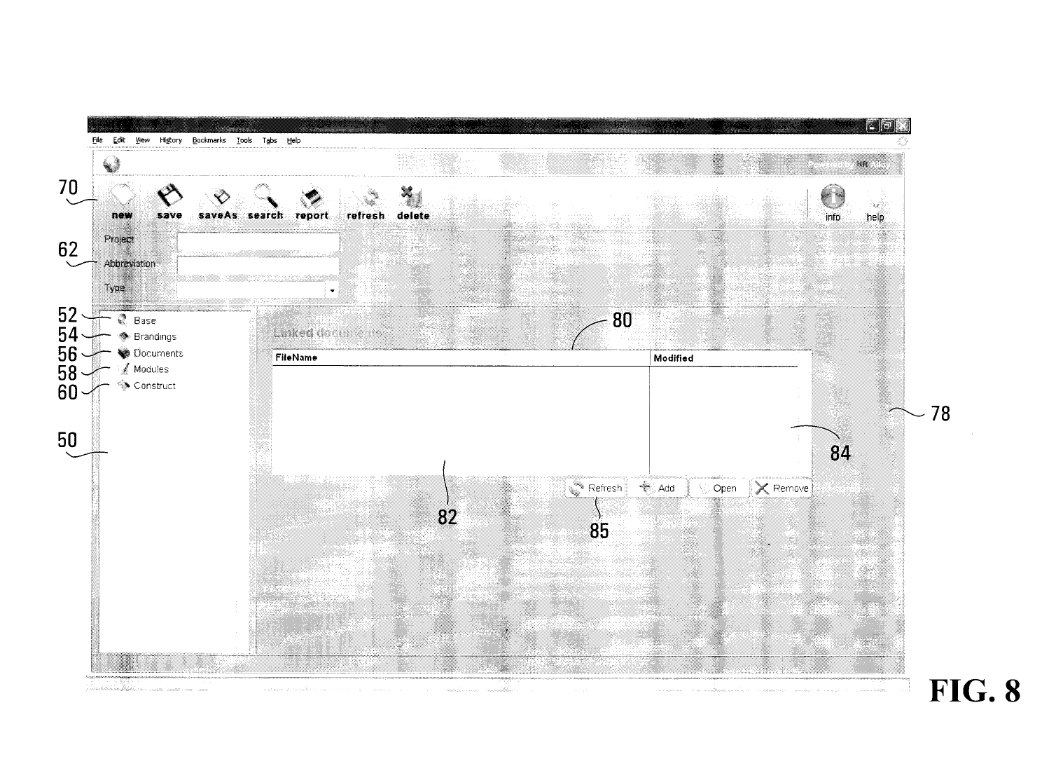

A selection of the Documents element 56 brings the author 19 to the window shown at FIG. 8. Note that the area 50, the buttons 70 and the area 62 are the same as the previous window. An area 78 contains a table 80 that allows the author 19 to import documents, such as text documents, that can be used to build modules 32. For instance, in a certain project 20, the author 19 may require welcome messages, consent forms or assessment tests that are unique to the employer associated with that project 20 and that may not already be available in the resources library 28. In such case, the employer may make available to the author 19 sample documents for use in creating the project 20. These sample documents are imported in the project 20 via the table 80. Specifically, the table 80 contains a FileName column 82, where one or more documents associated with the project 20 are listed and a Modified column 84 that shows the documents on which modifications have been made. Below the table 80 is provided a set of controls 85, such as buttons, allowing manipulating the documents in the table 80. In this case, the controls 84 allow refreshing the table 80, adding documents to the table 80, opening documents, or deleting documents.

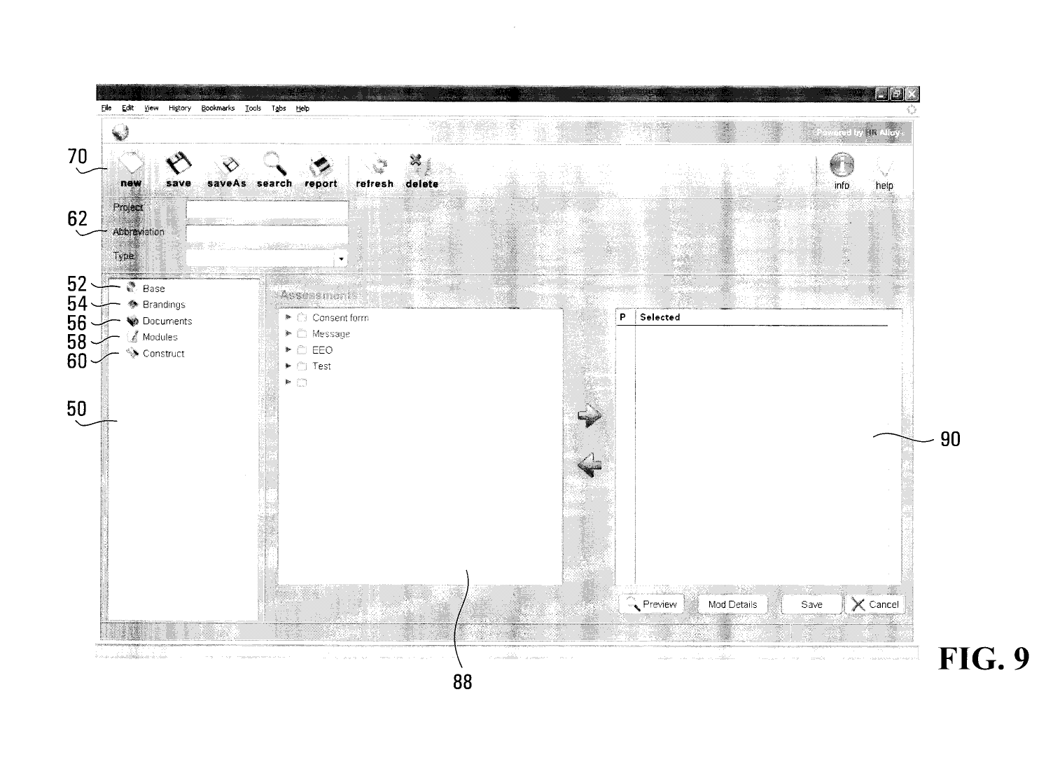

A selection of the Modules element 58 brings the author 19 to the window shown in FIG. 9. Note that the area 50, the buttons 70 and the area 62 are the same as the previous window. To the right of the area 50 are provided two areas 88 and 90 allowing the author 19 to select modules 32 for use in the project 20. The area 88 shows a folders list, where each selection (folder) corresponds to a module type. Several module types can be considered. Examples of types of modules include:

1. Consent Forms
Modules typically containing an explanation text and a question. Examples include text asking if a candidate consents to share information or review of his/her background, accepts to continue the process, etc.

2. Messages
Modules designed to provide information without gathering data from a candidate. Examples include a welcome page or message, overall instructions, emails to a candidate.

3. Equal Employment Opportunity (EEO) Forms
Modules used to gather information about a candidate. Examples include forms prompting a candidate to provide information such as: his/her name; his/her social security number; his/her sex; his/her race/ethnic identification such as Caucasian, Black, Hispanic, American Indian or Alaskan native, or Asian or Pacific Islander; handicaps; a position applied for: a position title; and where did he/she hear about the position applied for. Answers are typically stored in a candidate table, but they can also be stored in an answer table or both.

4. Tests
Modules designed to rate a candidate with his/her answers to a set of questions. Answers are typically stored in the answer table. Examples include: cognitive assessment tests; personality assessment tests; IQ tests; job specific tests (e.g. ‘Sales ability’, ‘Customer service’, ‘Call center agents’, etc.); career inventory and planing (e.g., accountant career goals) tests; attention and reflexes tests; motivation tests; etc.

5. Surveys
Modules designed to gather a candidate's opinion. Answers are typically stored in the answer table. Example include: individual preferences, feedback, etc.

6. Multi-Raters Feedback (MRF)
Modules used for multi-raters feedback. It is similar to a survey. A group of candidates fill out the same survey about one other candidate. Answers are typically stored in the answer table.

7. Simulations
Modules providing a virtual simulation to a candidate and typically created with the virtual simulation authoring tool unit 40 (as discussed further below).

8. Interviews
Modules designed to gather information about a candidate by an administrative employee. Examples include: interview guide.

It will be appreciated that these types of modules are presented for example purposes and that various other types of modules may be used.

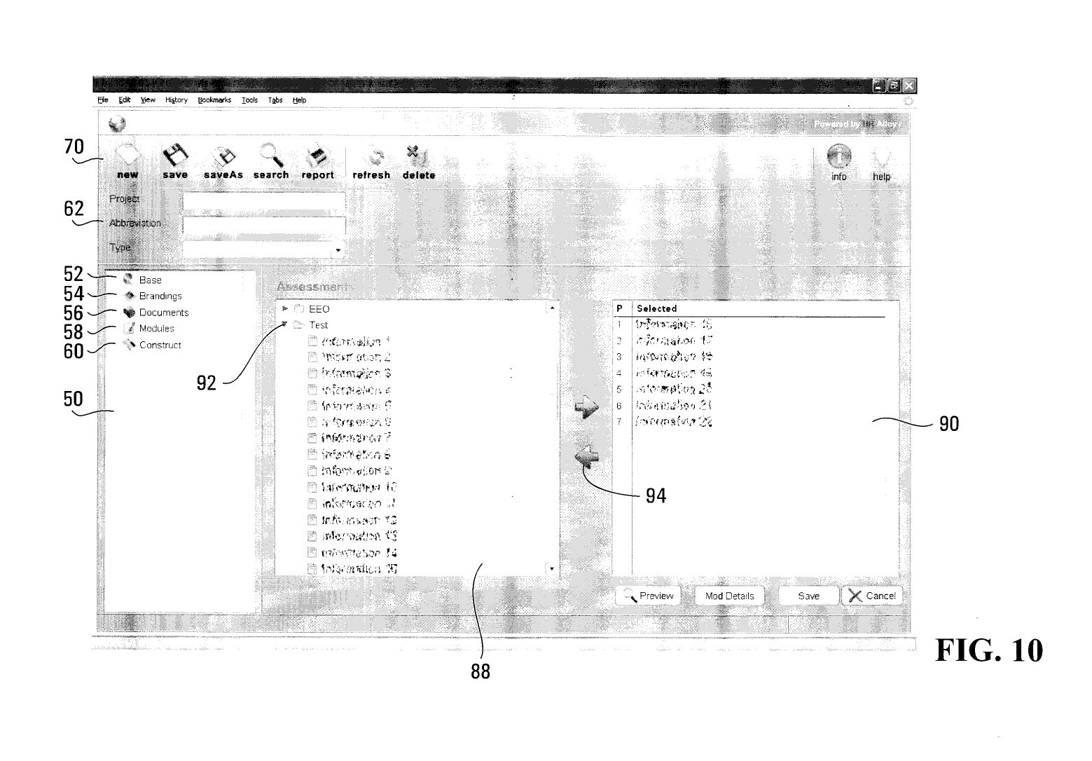

FIG. 10 shows what happens by selecting the test module type 92. The area 88 shows a menu of various test modules 32 that are available for selection. Here, the author 19 can chose different tests that the candidate 17 should be subjected to in order to evaluate the candidate 17 for the job. The area 90 contains a list of the different modules 32 that are selected from the area 88. The selection or de-selection can be made via controls, in this case control arrows 94. Accordingly, the list in the area 90 contains the modules 32 that would be part of the qualification management project 20. For example, the list may be as follows: (1) welcoming message (message module type); (2) consent form (consent form module type); (3) job preview virtual simulation (simulation module type); (4) IQ test (test module type); (5) job interactive virtual simulation (simulation module type); (5) thank you message (message module type); and (6) confirmation email (message module type).

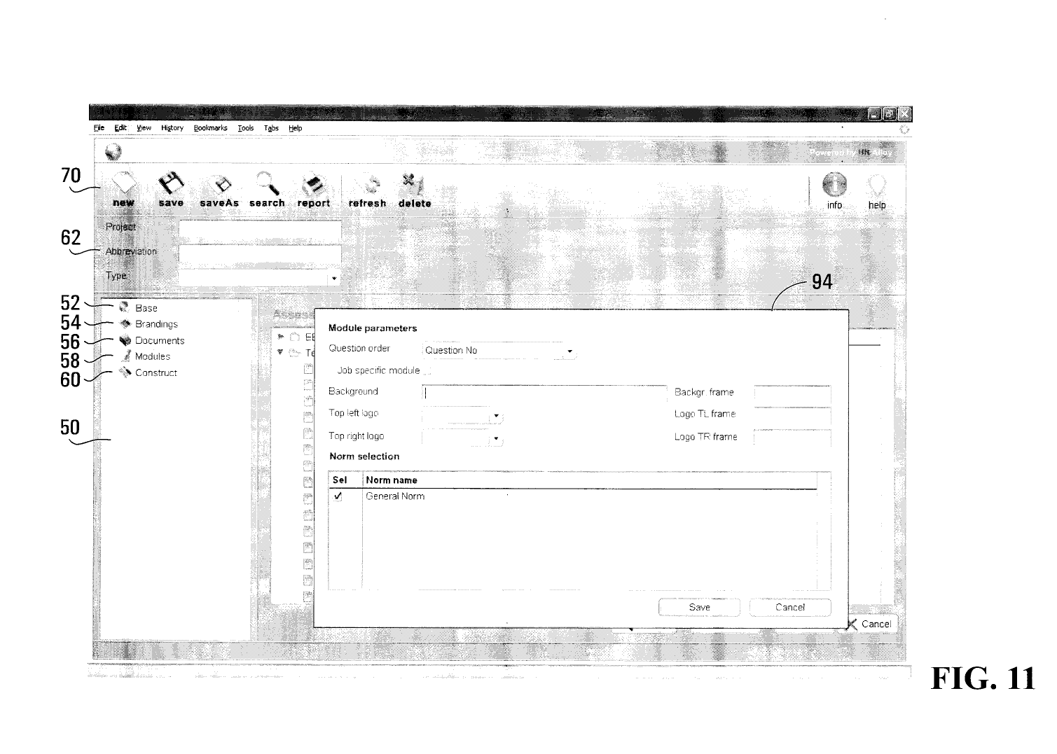

Any one of the modules listed in the area 90 can be selected and a Module parameters window 94 invoked, as shown in FIG. 11. The window 94 allows specifying different parameters for the selected module 32. One particular parameter in connection with test modules is the normalization parameter. When tests are scored, the returned marks are absolute numbers which provide little information by themselves unless they are put in a context. This is the case of many assessment tests, except perhaps the IQ test. By normalizing the results, however, it can be easily seen how a candidate compares to the rest of the population and thus provides more insight to his/her behavior. The normalization parameter will therefore perform a normalization of the results such as to show what those results mean in a specific context. Different normalizations can be made. In particular, the author 19 can chose the population group that will be used as a basis for the normalization. Examples of possible population groups include: urban white males; French speaking rural females; job level (e.g., senior, mid level, or lower level manager); and job type (e.g. accountant, police officer, teacher, etc.).

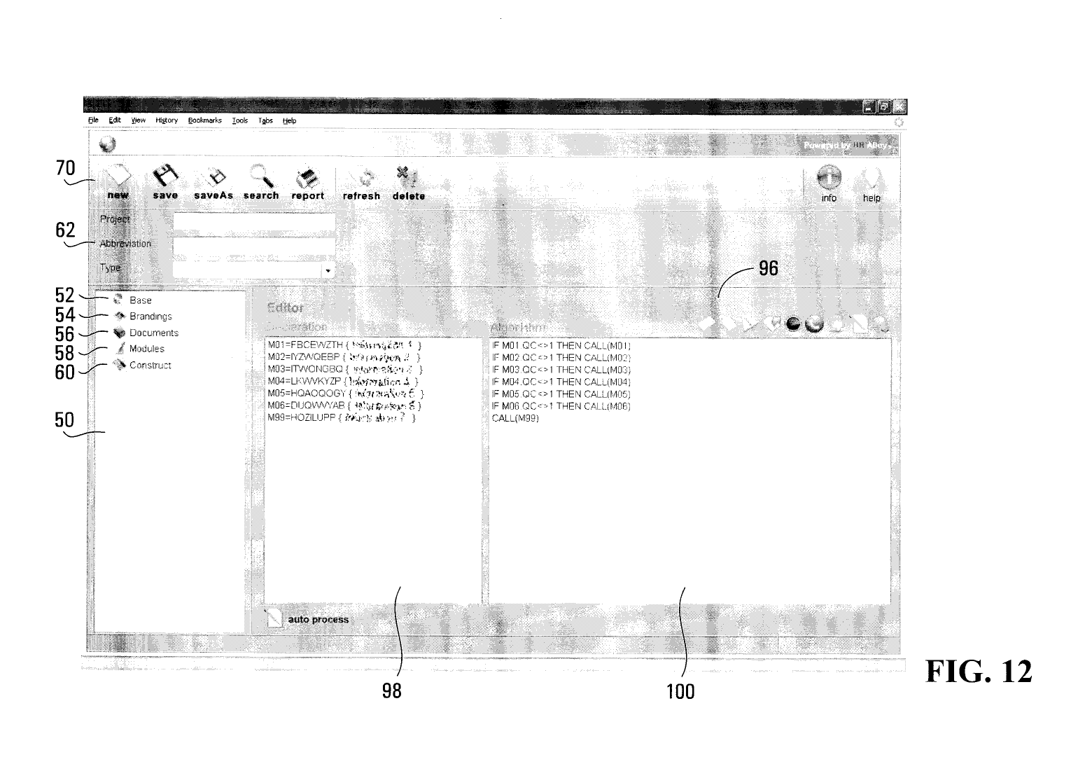

When the author 19 selects the Construct element 60, the window of FIG. 12 is shown. An area 96 allows the author 19 to create the workflow construct 36 of the qualification management project 20. The workflow construct 36 can be built by using any suitable programming language. In some cases, languages that can be interpreted by expression parsers may be used. The area 96 includes a declaration area 98 where declarations are put and an algorithm area 100 where the logic of how the different modules 32 are invoked is input. As a baseline, the authoring tool unit 26 is designed with logic that reads the modules 32 selected for the qualification management project 20 (in this case, that appear in the area 90 in FIG. 10), and creates a sample code designed to successively invoke the various modules 32 when the qualification management project 20 is run. Therefore, the built-in logic, if executed, would present the various modules to the candidate 17 one after the other.

The declaration area 98 and the algorithm area 100 can be used by the author 19 in order to provide the qualification management project 20 with more sophisticated functions. More particularly, they can be used by the author 19 in order to specify rules that define a sequence in which modules 32 of the qualification management project 20 will interact with the candidate 17 as the project 20 is run. This can involve specifying an order in which the modules 32 are to be run and/or one or more conditions determining whether certain modules 32 will be run or will not be run, including conditions associated with branching operations.

Branching is an execution or invocation of a module 32 only when a certain condition is met. For example, consider a situation where a test to be presented to the candidate 17 is sex dependent. If the candidate 17 is a male then test A is used, while if the candidate 17 is a female then test B is used. Conditional algorithms in the workflow construct 36 will determine which module 32 to invoke (test A or test B) depending upon the answer provided to the EEO form (male or female) by the candidate 17.

Another example of branching is a situation which requires that the qualification management project 20 continues to be run only when the candidate 17 has accepted conditions in a consent form. Accordingly, the logic in the workflow construct 36 looks for the answer to the consent form and only if the consent form has been accepted, then the modules 32 to perform the evaluation are invoked. Otherwise, the project 20 run is aborted, possibly after invoking a special message module 32 confirming to the candidate 17 his/her refusal of the conditions in the consent form.

Yet another example of branching is a situation where the number or kind of tests that the candidate 17 is asked to complete is conditional upon the score obtained at an earlier test. For instance, if the candidate 17 has obtained a very low score on one test, he/she may be dismissed by the logic of the workflow construct 36, instead of being directed to the next test. In such a case, after the test is completed and the score determined, the logic of the workflow construct 36 may invoke a farewell message module 32 instead of calling another test.

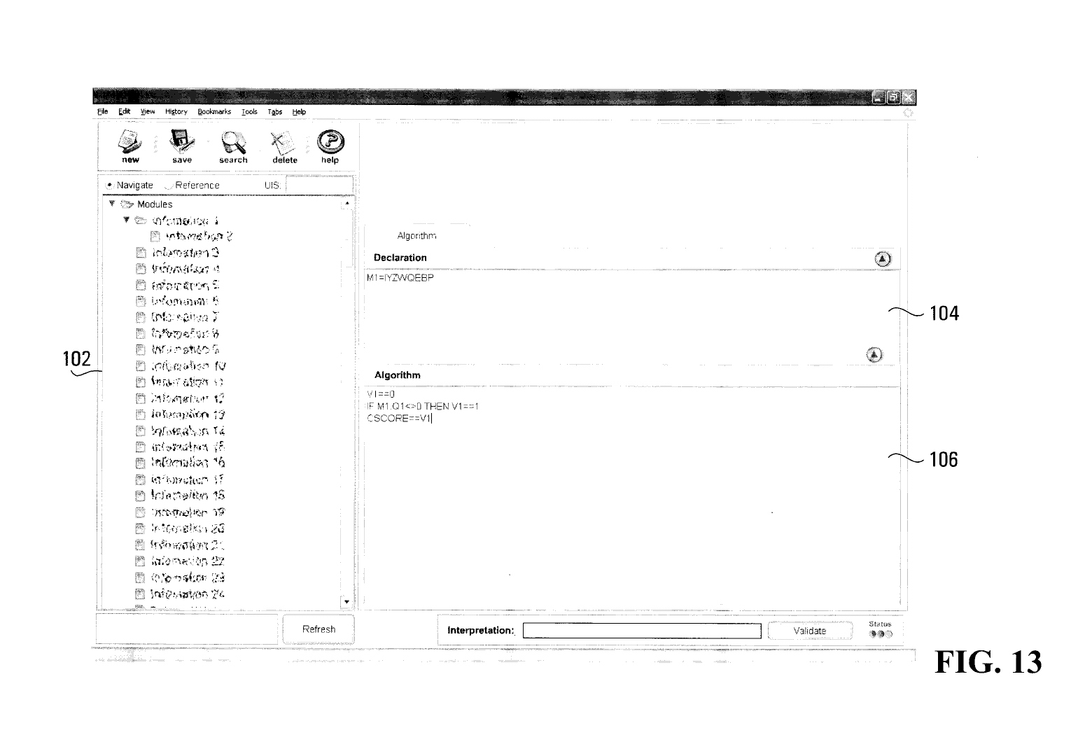

As discussed earlier, the constructs 34 associated with the modules 32 perform operations upon completion of execution of the modules 32. The constructs 34 can be built by accessing the window shown in FIG. 13. At the left is an area 102 in which there is a list of modules 32, while at the right are provided two superposed areas 104 and 106 where declarations and algorithms, respectively, can be input. The remainder of the window shown in FIG. 13 is similar to the windows described previously so no further details are deemed necessary.

The modules that appear within the area 102 are not necessarily those associated with the current qualification management project 20 but may include all the modules 32 that are available to the author 19 to choose from at the module selection stage. The logic that the author 19 builds by entering programming language at the window of FIG. 13 determines the one or more operations that the construct 34 will perform upon completion of execution of the associated module 32.

As mentioned above, one possible operation performed upon completion of execution of a module 32 is scoring or marking the performance of the candidate 17 in relation to that module 32. For instance, in the case of a module 32 implementing a text-based test, the scoring function implemented by the construct 34 associated with the module 32 computes a score on a basis of answers provided by the candidate 17 in responses to questions of the test. More particularly, the construct 34 includes program code that interprets the various answers according to built-in logic and provides a score. A simple scoring algorithm is one that accumulates the marks to individual questions to provide a collective score. Such simple scoring algorithm could be used for IQ tests, for instance. A more complex scoring algorithm is one that interprets the answers to provide insights about the personality or behavior of the candidate 17. For instance, the answers to the same question set can be interpreted to determine different behavioral traits, such as ascendancy, responsibility, emotional stability, sociability, cautiousness, original thinking, personal relations, and vigor, among many others. The interpretation of the score is based on interpretation keys that can be described as logic linking the answers to a particular behavioral trait. Once a given interpretation key has been developed, it can be coded via the window shown in FIG. 13.

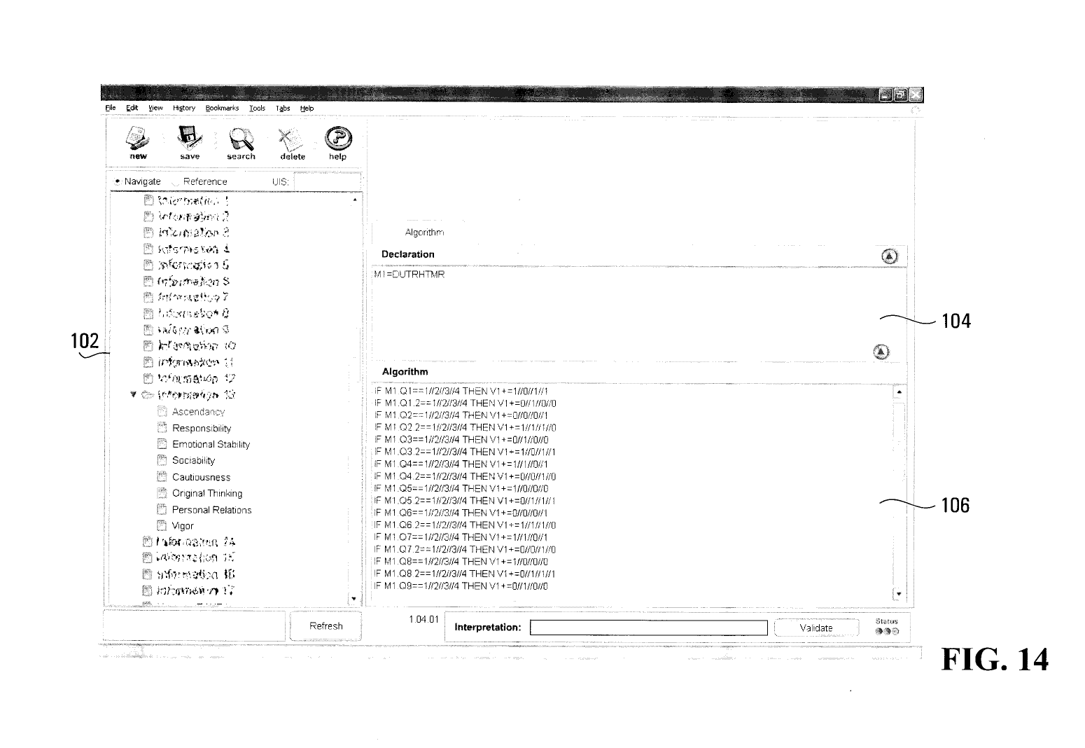

The window shown in FIG. 14, which is similar to the window shown in FIG. 13, shows that the author 19 has available for selection a series of constructs corresponding to common or frequently used interpretation keys. For example, a selected module 32 in the area 102 shows a sub-menu with different interpretation keys for which the code for the construct 34 is provided. In the example shown, ascendancy is selected and the area 106 shows the code that implements the interpretation key allowing evaluating ascendancy on the basis of the answers provided by the candidate 17.

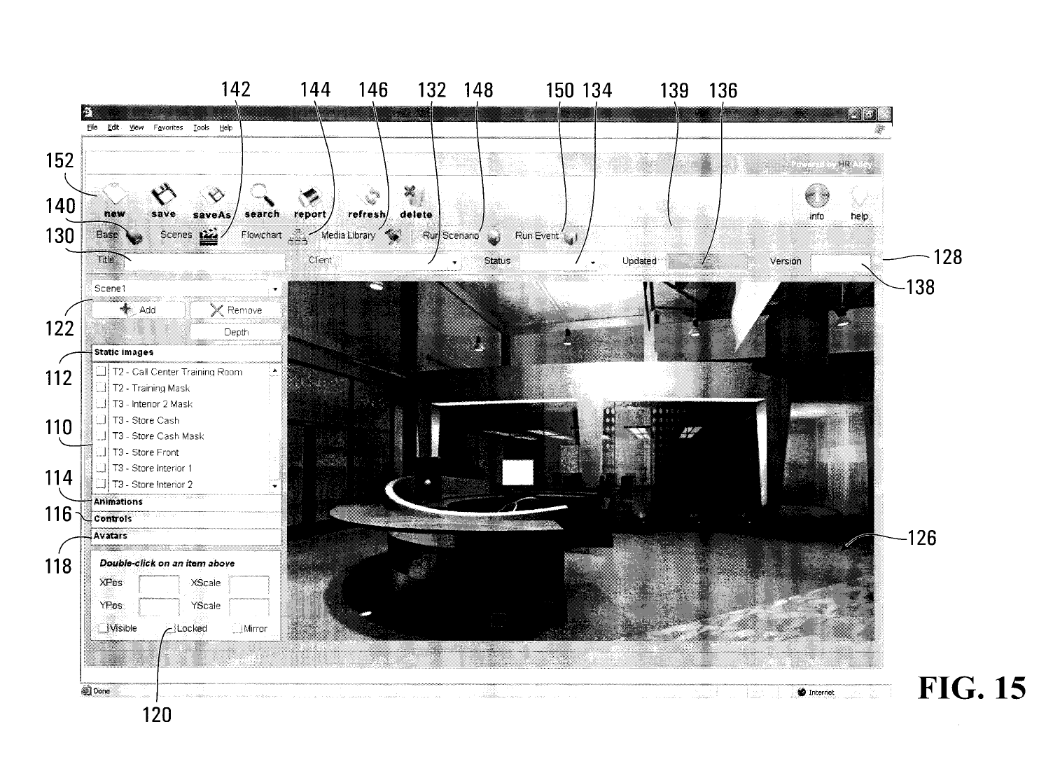

The design of modules 32 that correspond to a virtual simulation is done via the virtual simulation authoring tool unit 40. An example of operation of the virtual simulation authoring tool unit 40 will now be discussed with reference to FIGS. 15 to 38. These figures show different example manifestations, in this case windows, of a GUI of the virtual simulation authoring tool unit 40 that allow the author 19 to input commands using any suitable input device of the client computer 22, such as a keyboard, a mouse, a microphone, a stylus, a touchscreen, or another input device.

FIG. 15 is a window that the author 19 can see at the beginning of creation of a virtual simulation module. The window has an area 110 with a list of selectable elements, such as a Static images element 112, an Animations element 114, a Controls element 116, and an Avatars element 118. At the bottom of the window is provided a set of controls 120 that allow determining how graphical objects will behave, such as a position on the X axis, a position on the Y axis, the X axis scale, the Y axis scale, and whether the graphic object is visible, locked or a mirror image. At the top of the area 110 is provided a set of controls 122 that identify a scene that is being designed, allow adding or removing graphical objects, and determine a relative depth of a graphical object.

On the right of the area 110 is a large area 126 that constitutes a viewing pane in which graphical objects that have been selected for the scene can be viewed by the author 19. Above the area 110 and the area 126 is a status bar 128 providing information about the qualification management project 20, such as the name of the project 20 in field 130, the client for whom the simulation is made in field 132, the status in field 134, and update and version information in fields 136 and 138. Above the status bar 128 appears a menu 139 allowing the author 19 to access different functionalities of the virtual simulation authoring tool unit 40. The following elements can be selected, Base 140, Scenes 142, Flowchart 144, Media Library 146, Run Scenario 148, and Run Event 150. Above the menu 139 are located a series of buttons 152 that correspond to typical commands, such as New, Save, SaveAs, Search, Report, Refresh and Delete.

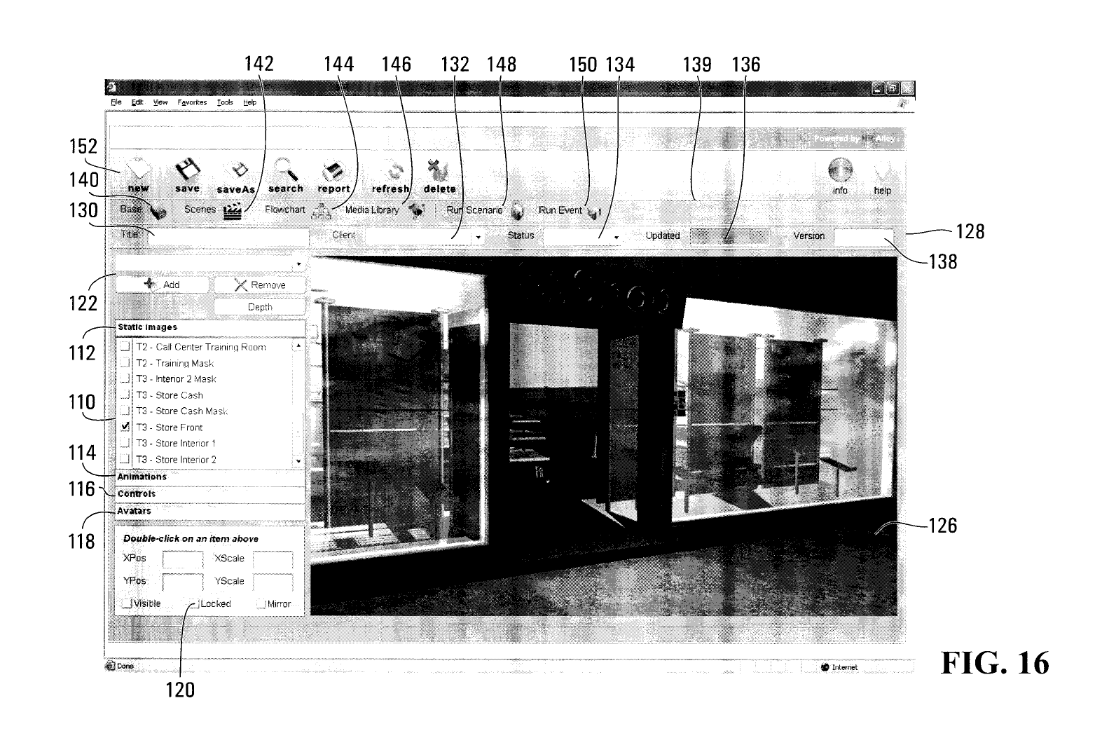

From a visual perspective, virtual simulations are structured in terms of scenes. A scene would usually include a background or static image that can be selected via the GUI using the window shown in FIG. 15. By clicking the Static images element 112, a menu is shown listing the available backgrounds. For example, in FIG. 15, the viewing pane in area 126 shows a background image that corresponds to a reception area. FIG. 16 shows a different example, where the author 19 has selected a “Store Front” background image.

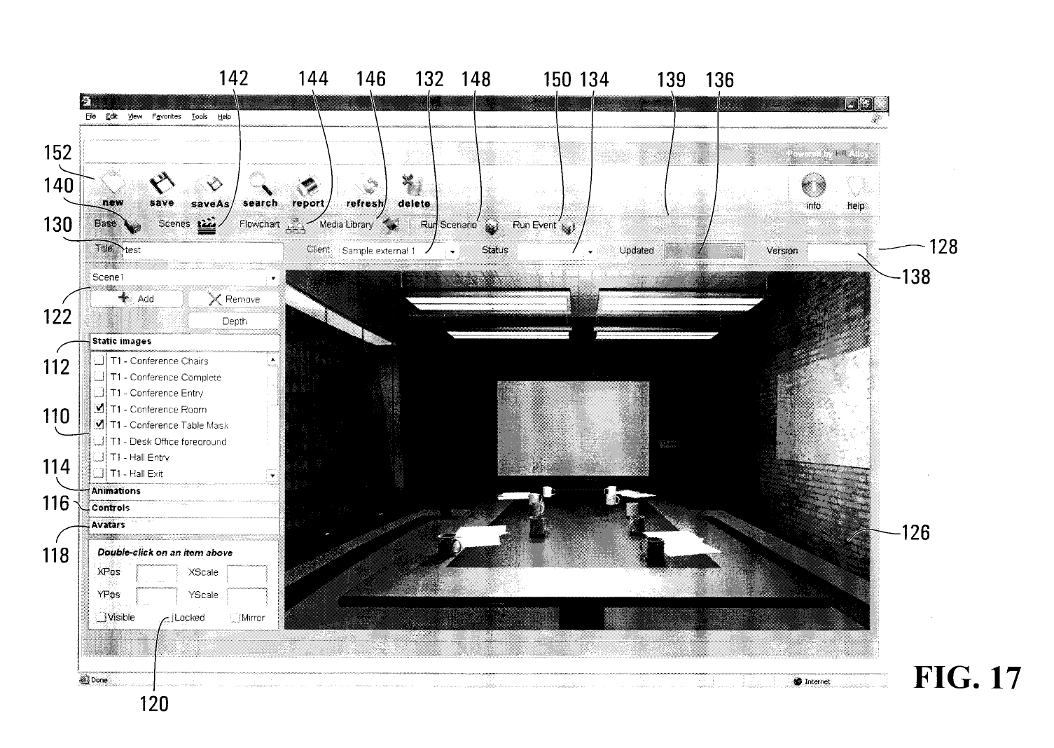

FIG. 17 provides yet another example of use of the GUI for selecting a background. Here, the author 19 has selected two static images, namely a conference room and a conference table mask. Both images appear in the viewing pane in the area 126 as overlaid. Therefore, the control 112 allows “stacking” graphical objects by individually selecting these objects such as to create complex scene backgrounds.

The static images that are selected allow for little or no interaction with the candidate 17. They are intended mostly to provide a pictorial representation of context for the virtual simulation.

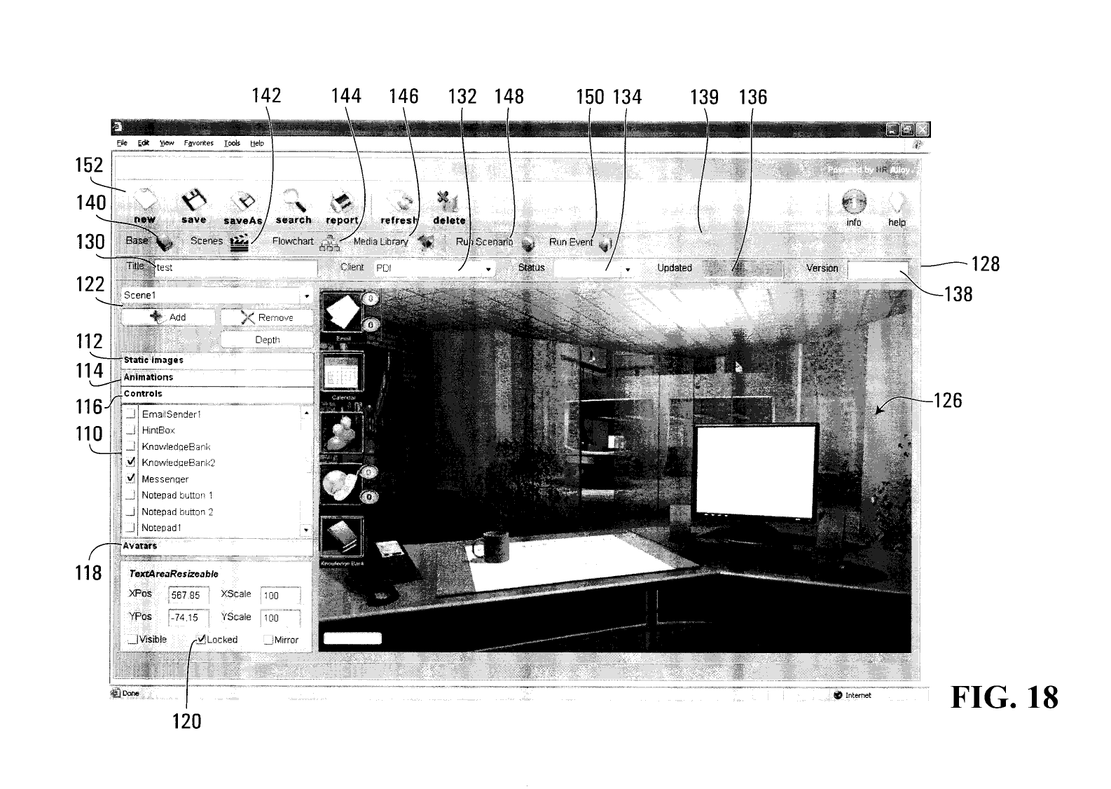

The controls element 116 allows access to interactive objects that can interact with the candidate 17 during the virtual simulation. These interactive objects will be selected according to the virtual simulation that is being run. Typically, the interactive objects constitute “tools” allowing the candidate 17 to accomplish a certain task or they convey information to and/or collect information from the candidate 17. The interactive objects can be set to appear anywhere within the area 126. For example, in the window shown in FIG. 18, five interactive objects have been selected and are graphically represented by icons located along the left border of the viewing pane of the area 126.

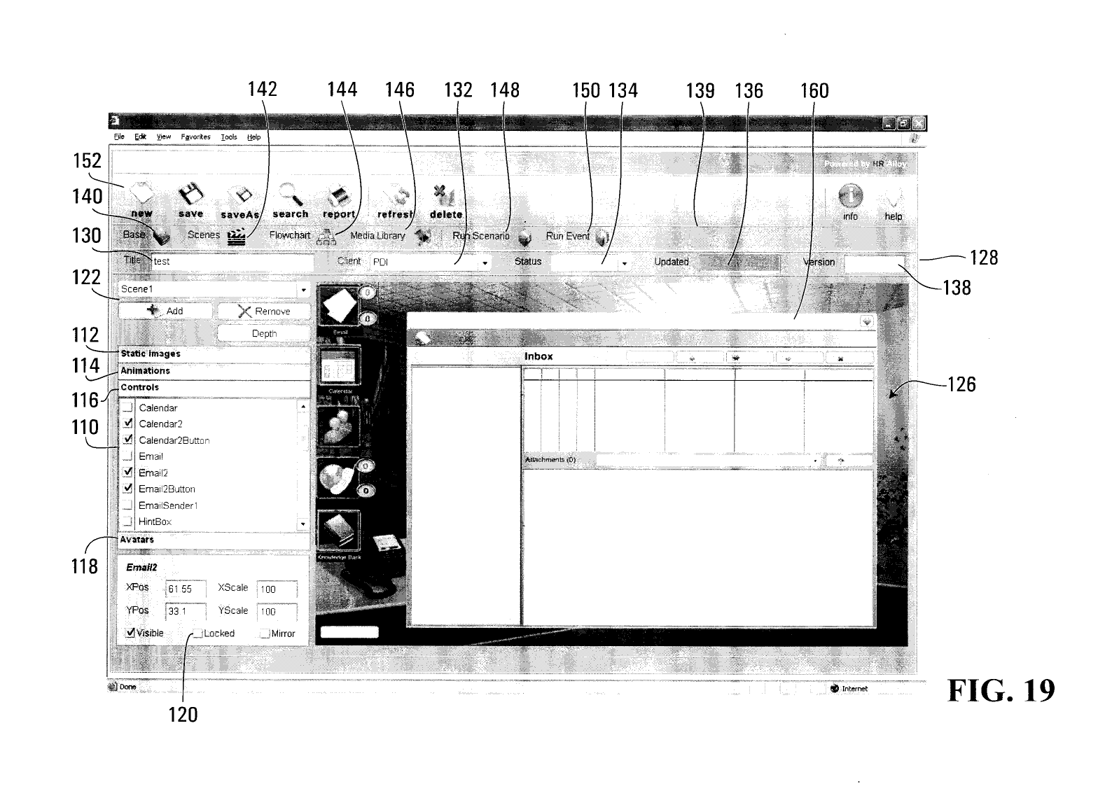

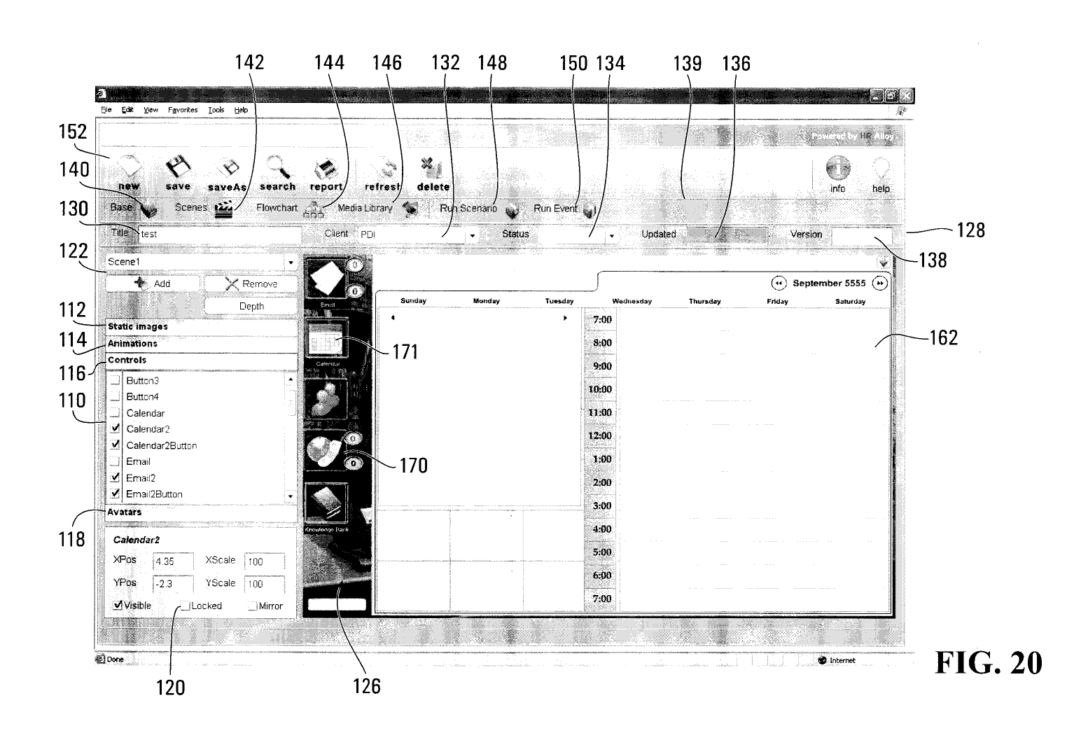

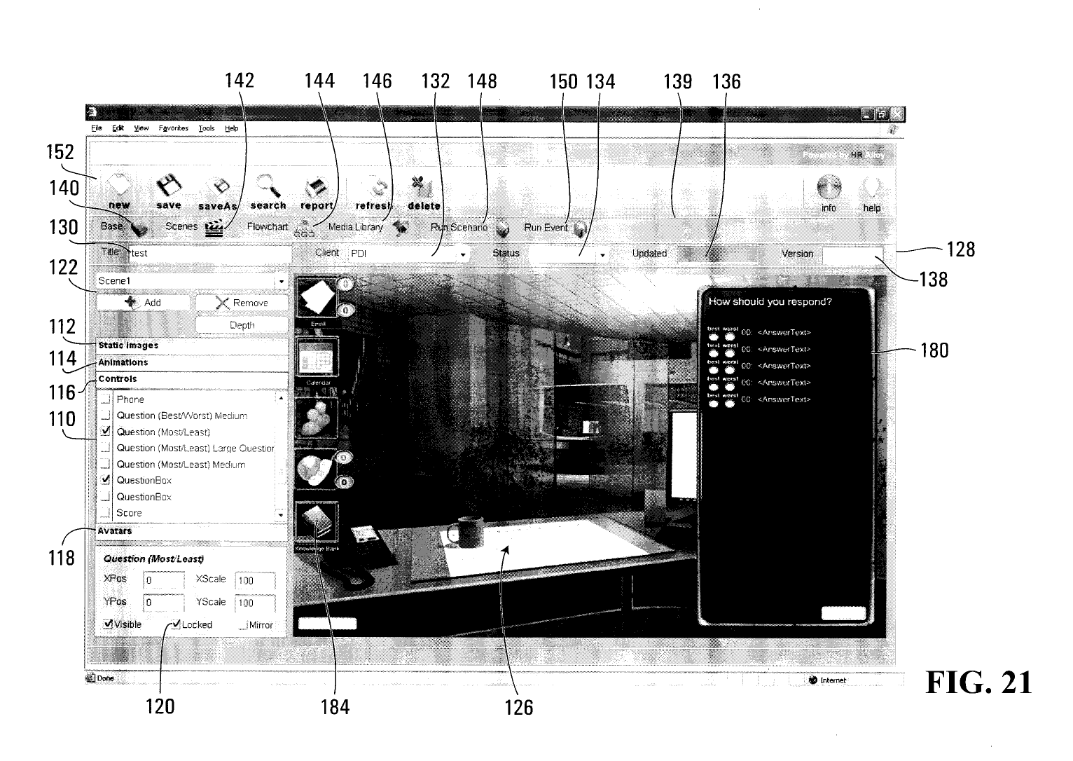

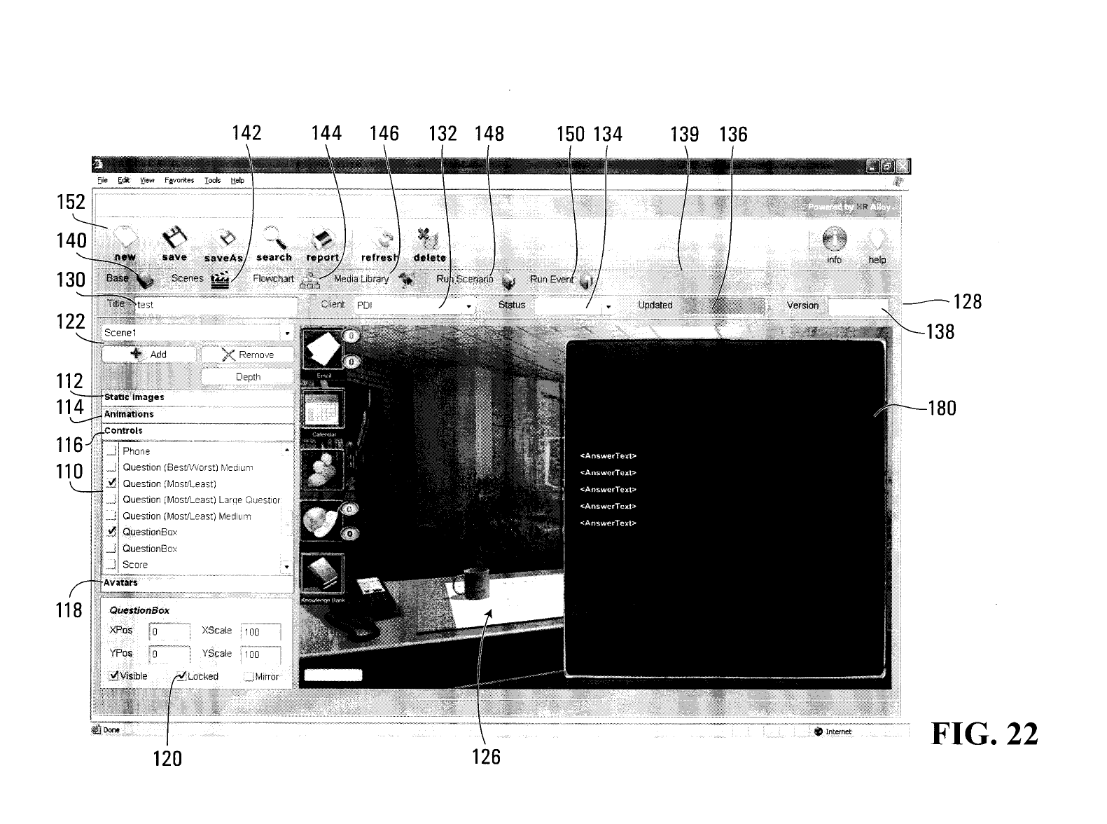

Examples of interactive objects that are suitable for a virtual simulation in an office environment include:
An interactive email object to simulate an email system functionality. For instance, it can simulate arrival of an email, allow the candidate 17 to open the email, read the email, and respond to the email. The window shown in FIG. 19 provides an example of the view that the candidate 17 can see when invoking an email object. A window 160 pops up simulating an “in-box” of an email system. In that window, the candidate 17 can read an email, file the email in an appropriate folder, and if enabled, compose a response, select recipients, and send the response. When the email object is not active, it appears as an icon 169, showing the total number of emails that have arrived and those that have not yet been read.
An interactive calendar object to simulate an electronic calendar system functionality. For instance, it can simulate a calendar and allow the candidate 17 to see a schedule of activities, such as a daily schedule, weekly schedule or a monthly schedule. The window shown in FIG. 20 provides an example of the view that the candidate 17 can see when invoking a calendar object. A window 162 pops up simulating a calendar page. In that window, the candidate 17 can determine a daily schedule such as what meetings are planed, and if enabled allow the candidate 17 to create new events such as meetings, modify existing events by cancelling them or re-scheduling them. When the calendar object is not active, it appears as an icon 171.
An interactive telephone object to simulate a telephone system functionality. For instance, it can simulate a call in which information is provided to the candidate 17 (e.g., via text displayed on the display or sound produced by a speaker of the client computer 10). Optionally, choices for possible answers or other statements may be presented to the candidate 17, enabling the candidate 17 to select an answer or other statement. When the telephone object is not active, it appears as an icon.
An interactive voice mail object to simulate a voice mail system functionality. For instance, when invoked by the candidate 17, a window pops up to provide in text form a voice mail message (alternatively, the voice mail message may be provided in audible form via a speaker of the client computer 10). Optionally, the window can present choices for possible answers, enabling the candidate 17 to select an answer. When the voice mail object is not active, it appears as an icon. In FIG. 20, the icon is shown at 170. A counter also appears next to the icon to show the total number of voice mails that have been received and those that have not been considered.
An interactive instant messenger object to simulate an instant messenger system functionality. For instance, when invoked, an instant message window conveying information appears on the candidate's display. Optionally, the information also provides the possibility for an answer. This is shown in the example shown in FIG. 21. The window 180 provides a series of possible answers the candidate 17 can chose from. The selection of an answer is made by clicking on the appropriate selection. Larger text can be accommodated by a larger window, as shown in FIG. 22. When the instant messenger object is not active, it appears as an icon. In FIG. 21, the icon is shown at 182.
An interactive knowledge bank object. Simulates a database that delivers information to the candidate 17. When invoked, the information appears in a text box on the candidate's display. When the knowledge bank interactive object is not active, it appears as an icon. In FIG. 21, the icon is shown at 184.

It will be appreciated that these examples of interactive objects are presented for example purposes and that various other types of interactive objects may be used (in particular, for virtual simulations associated with different environments).

The avatars element 118 can be selected via the area 110. In a specific example of implementation, an avatar is a graphical representation of a colleague, coworker or other person the candidate 17 interacts with during the virtual simulation. For example, an avatar can be caused to take different postures and also talk to the candidate 17 via speakers or any other suitable sound producing device. The avatars can also show a limited degree of animation. For instance, when they talk, the lips can move in accordance with the speech.

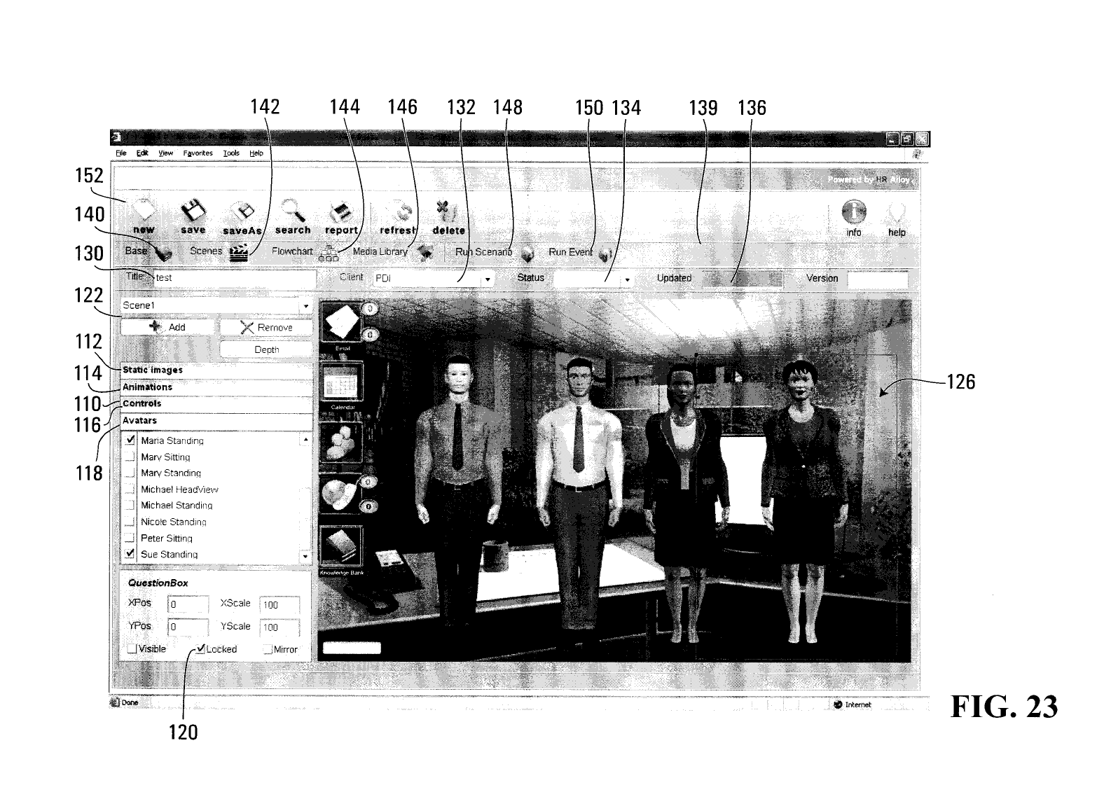

As shown in the window of FIG. 23, several avatar choices are available to the author 19 when designing the virtual simulation. The avatar choices are listed in the avatars element 118. The avatars may be distinguished from one another on the basis of:
Sex. Male or female avatars can be selected.
Race. Avatars of different races can be selected, such as Caucasian, Black, Hispanic, American Indian or Alaskan native, or Asian or Pacific Islander.
Dress code. Avatars can be dressed differently such as with business attire, casually or with a uniform.
Posture. An avatar can be standing, sitting or have some other posture.

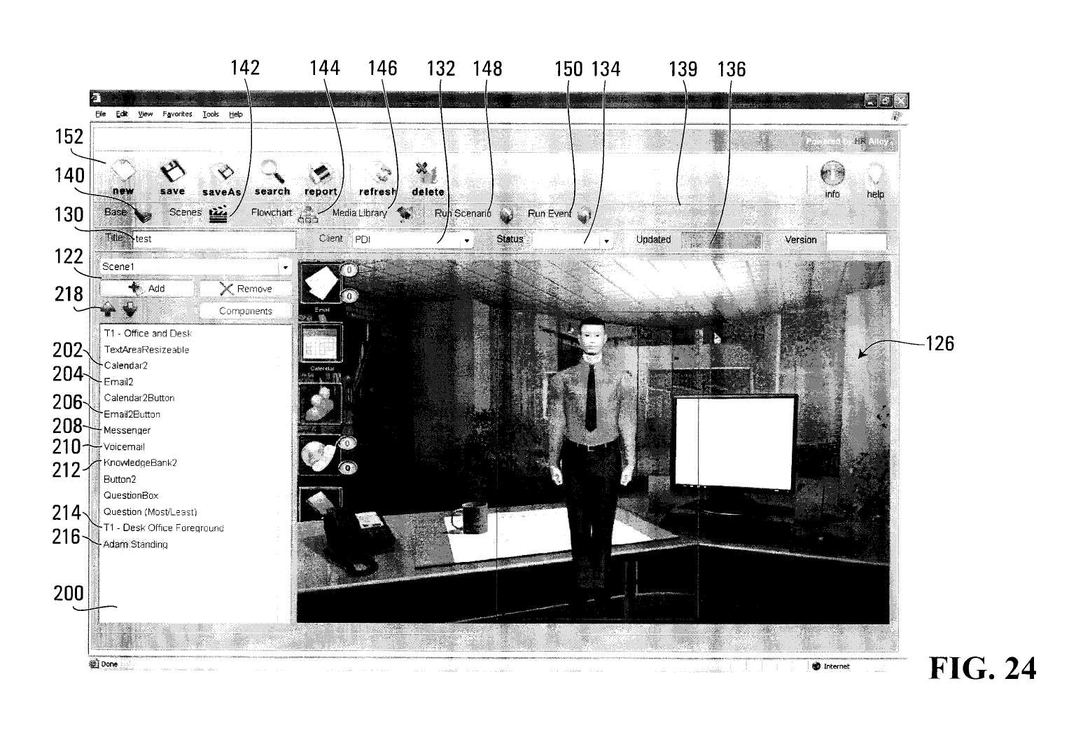

The window shown in FIG. 24 illustrates the manner in which the author 19 can determine the relative position (foreground or background) of the various graphical objects selected for the scene, namely the background, the interactive objects and the avatar. In this case, the depth control is accessed via the “Depth” button of the controls 122 that appears in FIG. 15. When this button is pressed, the window shown in FIG. 24 appears with an area 200 that lists all the objects that have been selected for the scene. The order in which the objects are listed is the order in which they are graphically overlaid in the viewing pane 126. For instance, the office and desk that are part of the scene are at the top of the list. The calendar object 202 overlays the office and desk scenery. The email object 204 is in front of the calendar object 202. The email button object 206 (to invoke the email object) is in front of the email object 204. The messenger object 208 is in front of the email button object 206. The voicemail object 210 is in front of the messenger object 208. The knowledge bank 212 is in front of the voicemail object 210. The office desk 214 is in front of the knowledge bank 212. Finally, the avatar 216 is in front of the office desk object 214. Since the avatar 216 is at the foreground of the image it appears visually in front of everything else.

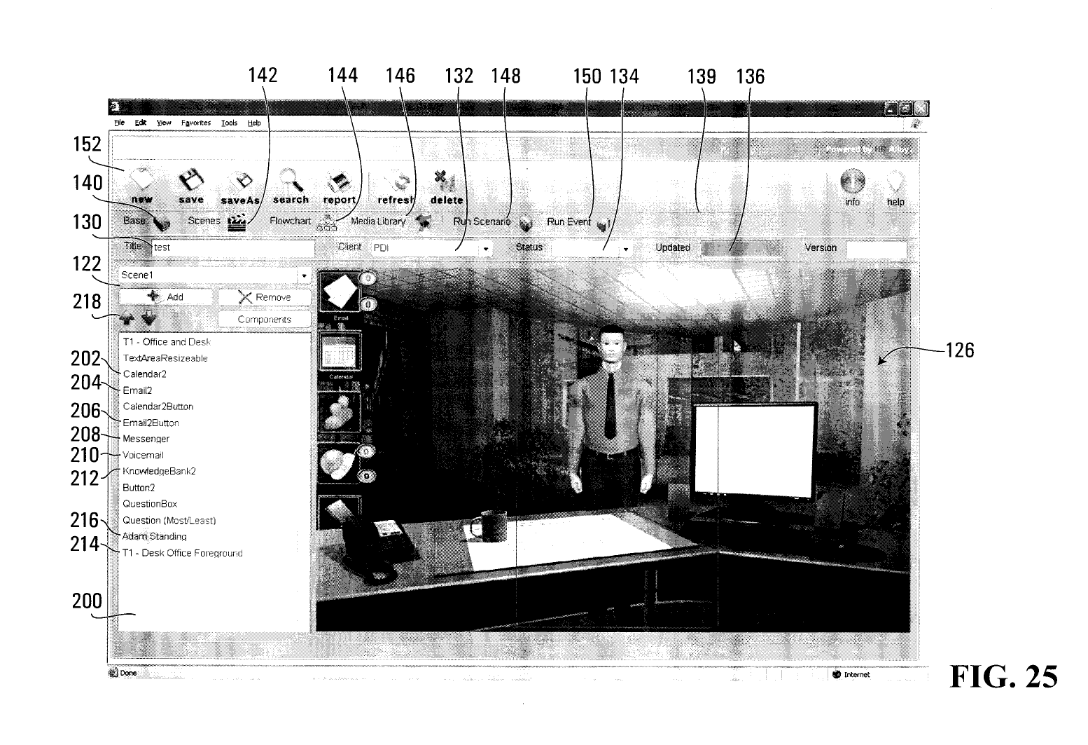

The relative visual position of any one of the objects in the stack can be controlled via the up and down arrows 218. For instance, the object is selected and by clicking the appropriate arrow 218 its position is changed toward the background or toward the foreground of the image. For instance, as shown in FIG. 25, the position of the avatar 216 has been changed to lay behind the office desk 214.

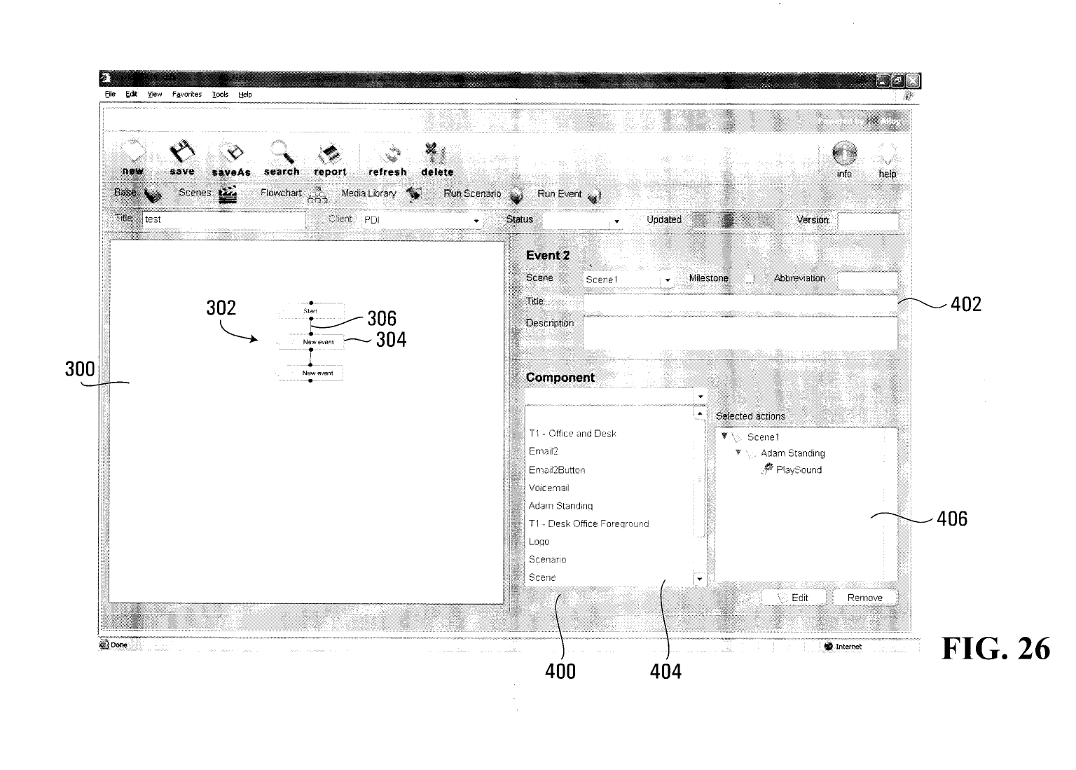

The windows shown in FIGS. 26 to 33 provide the author 19 with control over the behavior of the objects previously selected for the scene or scenes of the virtual simulation. The basis control is achieved via the window shown in FIG. 26. The action taking place during the virtual simulation is defined in terms of events. In this example, a virtual simulation can thus be viewed as having a scenario defined by a chain of events in the context of scenes. So, once the author 19 has created one or more scenes that will be used in the virtual simulation, the next step is to create the events.

The window shown in FIG. 26 has two main components. The first main component is an area 300 where the relationship between the various events is graphically shown. In other words, the area 300 displays an event tree structure 302 showing the logical relationship between the events and also describes the flow of events that takes place as the virtual simulation is being run. The event tree structure 300 is generated automatically as the various events are created. As the author 19 specifies characteristics of each event, those characteristics are noted and logical relationships defined and graphically represented in the area 300.

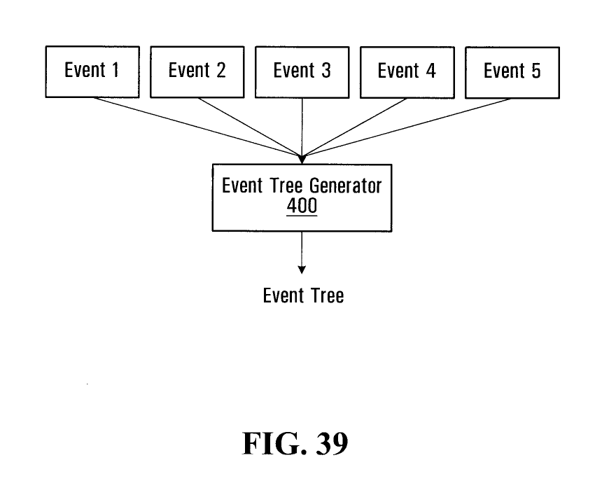

The generation of the event tree structure 302 is done by an event tree generator which is not apparent to the author 19, except of course for its output which is the event tree structure 302. A representation of the event tree generator is shown in FIG. 39. The event tree generator, denoted 400, is a software component that takes as input the various parameters that define each event to determine how to create the event tree structure 302. Specifically, the event tree generator 400 determines the order of the events in the virtual simulation. Secondly, on the basis of the logic of the various events, links are created between the events to create a path, from one event to the next event in the simulation. The links are particularly useful when branching points are encountered. A branching point occurs when the current event leads to two or more subsequent events, where the choice of the path to follow depends on some condition. An example of a condition is an action taken by the candidate 17. For instance, consider the situation where the candidate 17 is presented with an email message and a voice mail message. If the candidate 17 elects to open the email message, the event flow will go along one branch which includes further events associated with the email message. On the other hand, if the candidate 17 elects to open the voice mail message then the event flow will go along another branch which includes further events associated with the voice mail message.

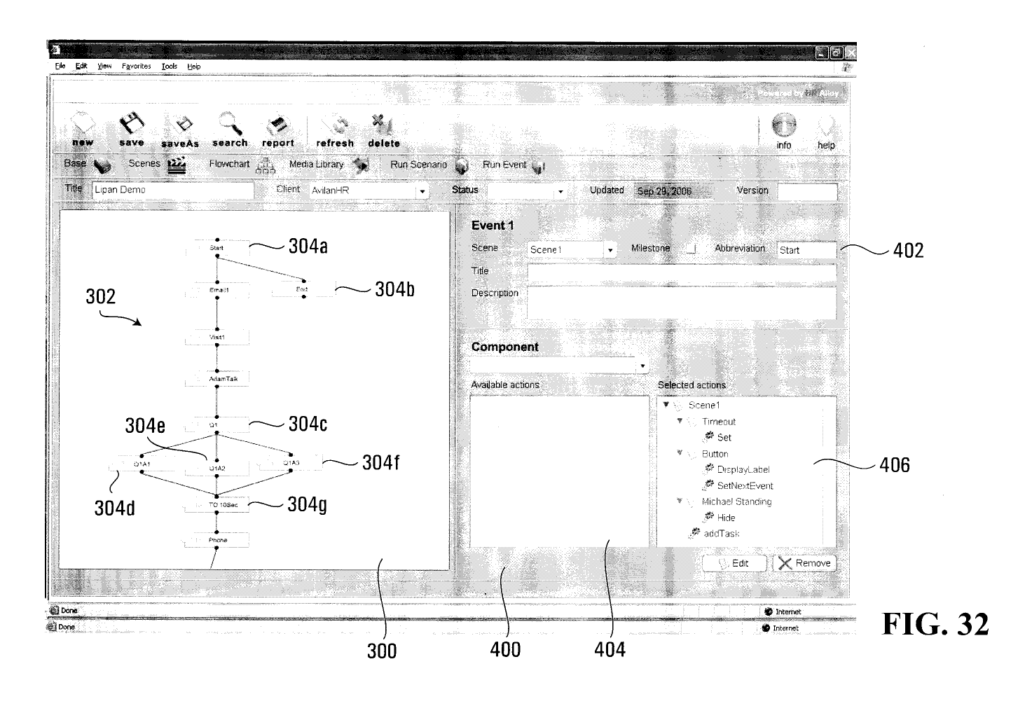

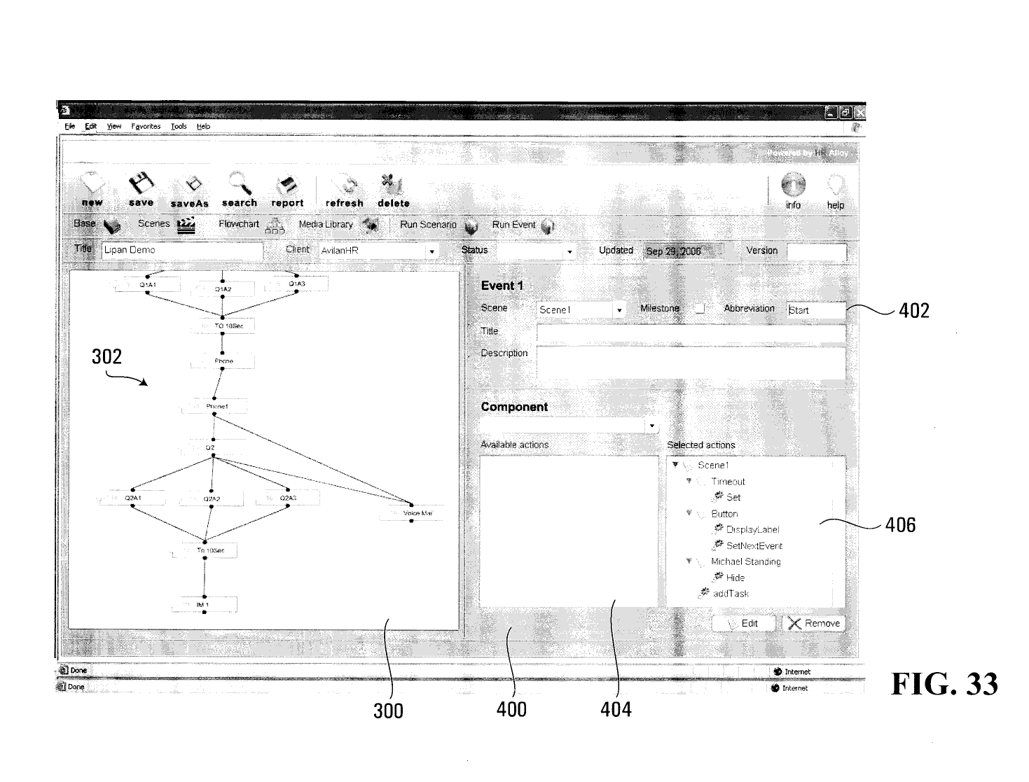

The output of the event tree generator 400 appears in the area 300 shown in FIG. 26. Individual events, which form nodes of the graphical tree structure 302, are shown by event boxes 304 with labels therein to identify them. The order of the events 304 is along a vertical axis, from top to bottom. In other words, the event box 304 at the top will be run before the event boxes 304 below. The links between the events appear as lines 306 between the respective event boxes 304. In a simple event tree structure 302 as shown in FIG. 26, the path from one event to the other is linear. In more complex event trees structures 302, such as those shown in FIGS. 32 and 33, where branching points exists, the links 306 allow to visually identify which are the possible pathways that arise form an event that defines a branching point.

In addition to graphically illustrating the flow of events and their logical relationship, the event tree structure 302 also provides a convenient navigation tool to select any one of the events in the virtual simulation. The selection is simply done by clicking with a pointer the event box 304 corresponding to the desired event and this causes an area 400 at the right of the viewing pane 300 to fill with information relating to the selected event. The area 400 contains several areas of information, namely a block of fields 402 that identify the event and the scene to which the event is associated. Below the block of fields 402 is provided a set of areas 404 and 406 that allow programming the actions or the behavior of various objects for the event. Specifically, the area 404 is in the form of a menu listing the various objects that have been previously specified for the scene. The area 406 displays the actions selected for the objects.

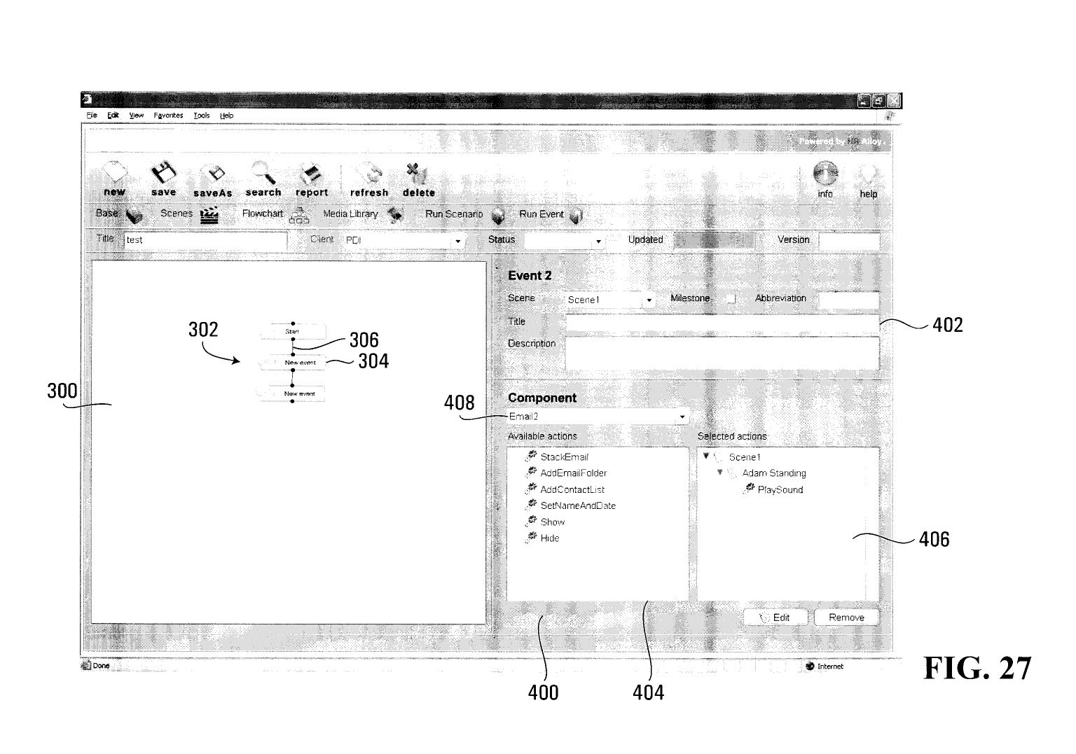

The window shown in FIG. 27 provides a more detailed example. The field 408 immediately above the area 404 shows that the email object has been selected. The list of objects that appeared previously in the area 404 was replaced by a list of actions or behaviors that are available for the selected object. The author 19 therefore can select among the available list those that are most suitable for the desired activity.

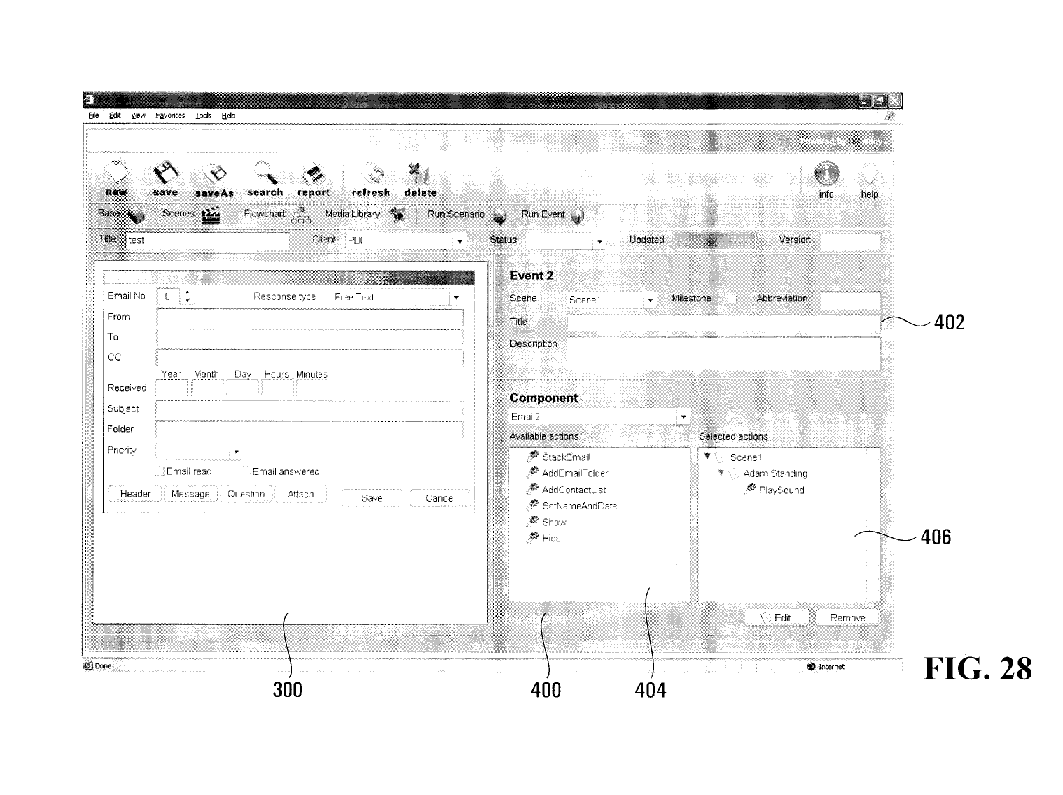

The window shown in FIG. 28 shows that the “StackEmail” action has been selected. This allows the author 19 to determine the content of an email message that the candidate 17 will receive during the virtual simulation. When this selection is made, a box pops up in the window pane that allows specifying the characteristics of the email message that the participant will receive. In this case, the following characteristics can be defined:
The email number.
The originator of the email.
The person to whom the email is sent.
Individuals copied in the email.
The time at which the email is received.
The subject of the email.
The folder in which the email is classified.
The priority of the email.
The message content of the email.

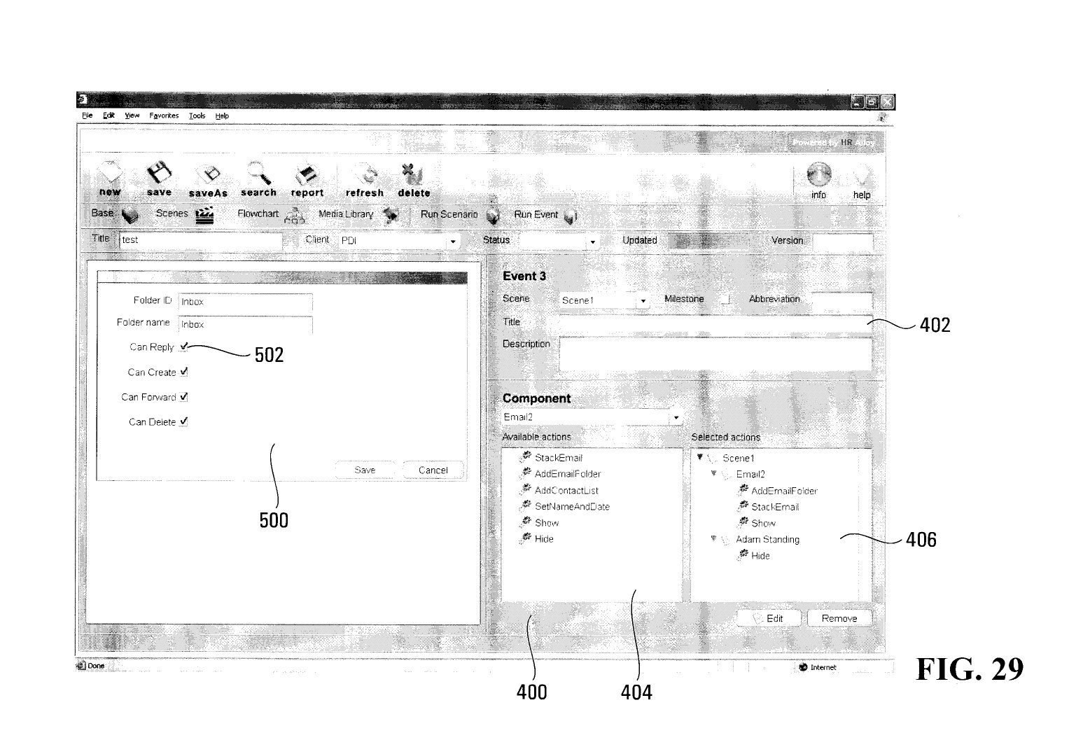

As shown in the window of FIG. 29, the author 19 can define certain other parameters of the email message by invoking a box 500, allowing specifying in check boxes 502 if the candidate 17 can reply to the email message, if the candidate 17 can create a new mail message, if the candidate 17 can forward the email message, or if the candidate 17 can delete the email message.

The behavior of other interactive objects listed earlier, except avatars that will be discussed later, can be defined in a similar fashion. For each object, the virtual simulation authoring tool unit 40 provides a set of available functions or actions from which the author 19 can chose. For example, in the case of a voice mail object, the author 19 can define the content of the message stored and provide the candidate 17 with the option to respond or not respond. If the option to respond is enabled, a list of possible responses or actions can be provided so that the candidate 17 can chose the one he/she thinks is the most appropriate to the situation. In the case of a calendar object, the author 19 can define entries such as meetings that can be read by the candidate 17. Again, the calendar object can be enabled to receive input from the candidate 17, such as create new events, alter existing ones, or delete them.

When an action in connection with an object is selected, a code generator (not shown) in the virtual simulation authoring tool unit 40 produces the necessary lines of program code such that during the execution of the virtual simulation the desired behavior will be obtained. The language produced by the code generator may be any suitable language. In some cases, languages that can be interpreted by expression parsers may be used.

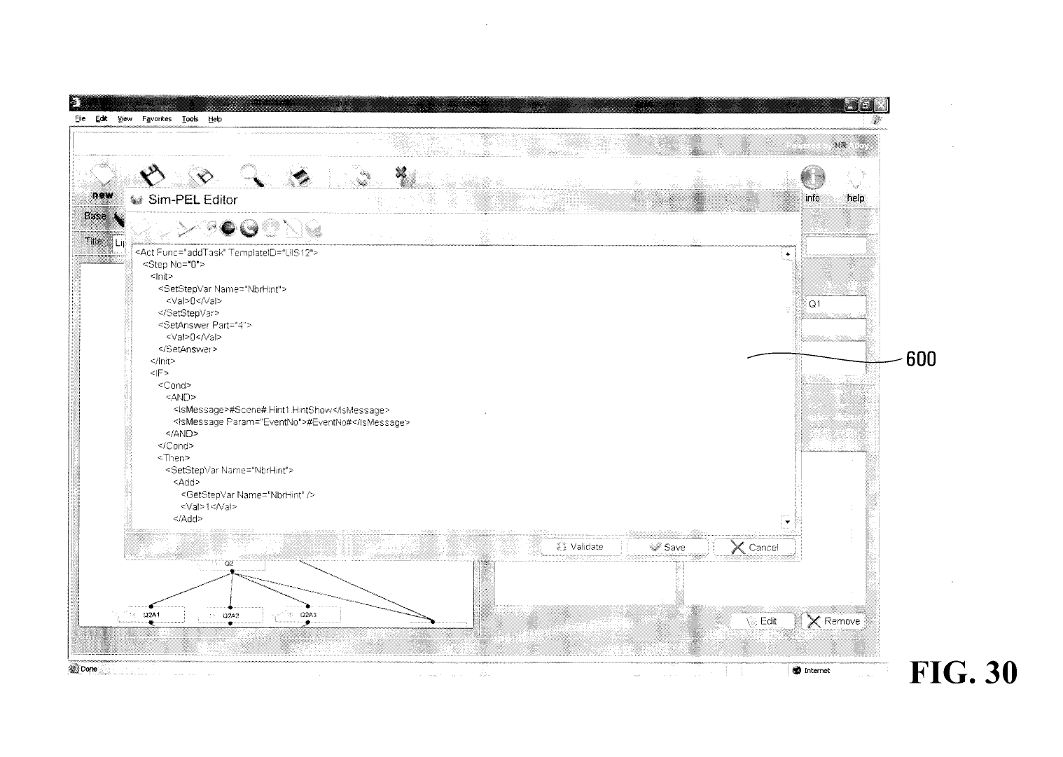

While the use of a code generator is very practical and can be used for defining often-used actions, there are some limitations to the range of options that are available. For that reason, a code editor is provided for allowing the author 19 to input code that determines the behavior of the object and that can be used to obtain some very specific and sophisticated actions. FIG. 30 illustrates a code editor window 600 open. The author 19 can input lines of code that specify desired actions and save them such that, when the virtual simulation is run, the action will be produced.

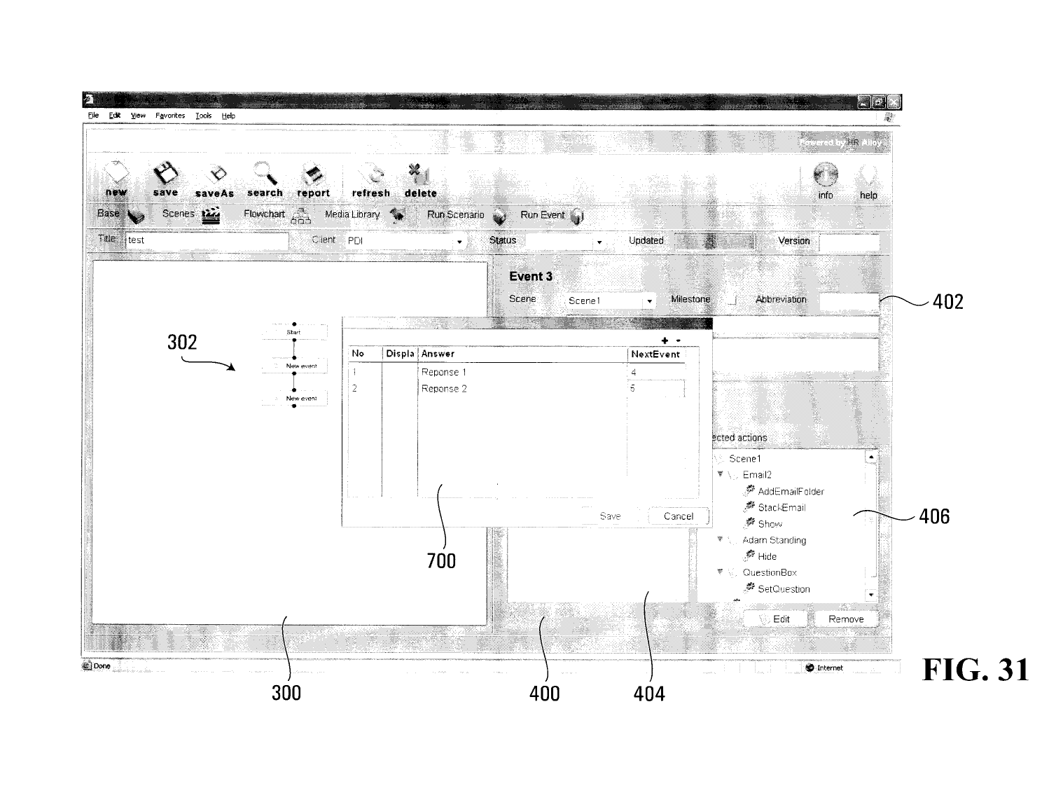

A specific control exists that allows determining at the end of a given event which event will follow next. This is shown in the window depicted in FIG. 31, where a box 700 provides a list of options in terms of conditions that may arise and the corresponding event to be triggered. In this specific example, the candidate 17 is asked a question in the current event and the event that will follow next is determined on the basis of the answer provided to the question. If response 1 is provided then the event that will be triggered is event number 4. In contrast, if response 2 is provided then event number 5 follows. This is a simple example of branching where the branching condition is the response to a question. Since only two possible answers (response 1 and response 2) define the branching tree, the box 700 contains only two entries. It will be appreciated that much more entries can be provided to create more complex and sophisticated conditions to determine which limb of the branch to follow depending upon the actions taken by the candidate 17.

For example, the following occurrences during the virtual simulation can be used in determining the path to follow at a branching point:
The response by the candidate 17 to a question;
The time taken by the candidate 17 to perform a certain action or respond to a question. For instance, if the candidate 17 does not know what to do, any subsidiary questions to the main questions are bypassed and the simulation flow moves to a different event.
The choice made by the candidate 17 in interacting with objects. For example, the candidate 17 may be faced with a voice mail message and an email message. The selection of which one will be handled first determines the event that will be triggered subsequently.

It will be appreciated that these are presented for example purposes and that various other occurrences during the virtual simulation can be used in determining the path to follow at a branching point.

The ability to create branching points in the events flow constitutes a very powerful tool that enables the creation of dynamic simulations that can create a higher level of challenge for the candidate 17. Accordingly, the results of those dynamic simulations can provide a better assessment of the suitability of the candidate 17 for a job, for example. The window pane 300 in FIGS. 32 and 33 provides more detailed examples of branching situations. In FIG. 32, three branching points exist in the event tree structure 302. The first branching point originates at the start event box 304a. If a particular condition arises there, the simulation aborts by leading to the end box event 304b.

The second branching point occurs at the event 304c which corresponds to a question. Depending upon the answer to the question, the event flow can continue with subsidiary questions at events 304d, 304e or 304f. The last branching point is at event box 304g. This is a reverse branch where the limbs lead to a common point. Here, the event boxes 304d, 304e and 304f all lead to the common event box 304g.

Similar branching point situations arise in the event tree structure 302 in the window shown in FIG. 33 (which is a continuation of the event tree structure 302 of FIG. 32).

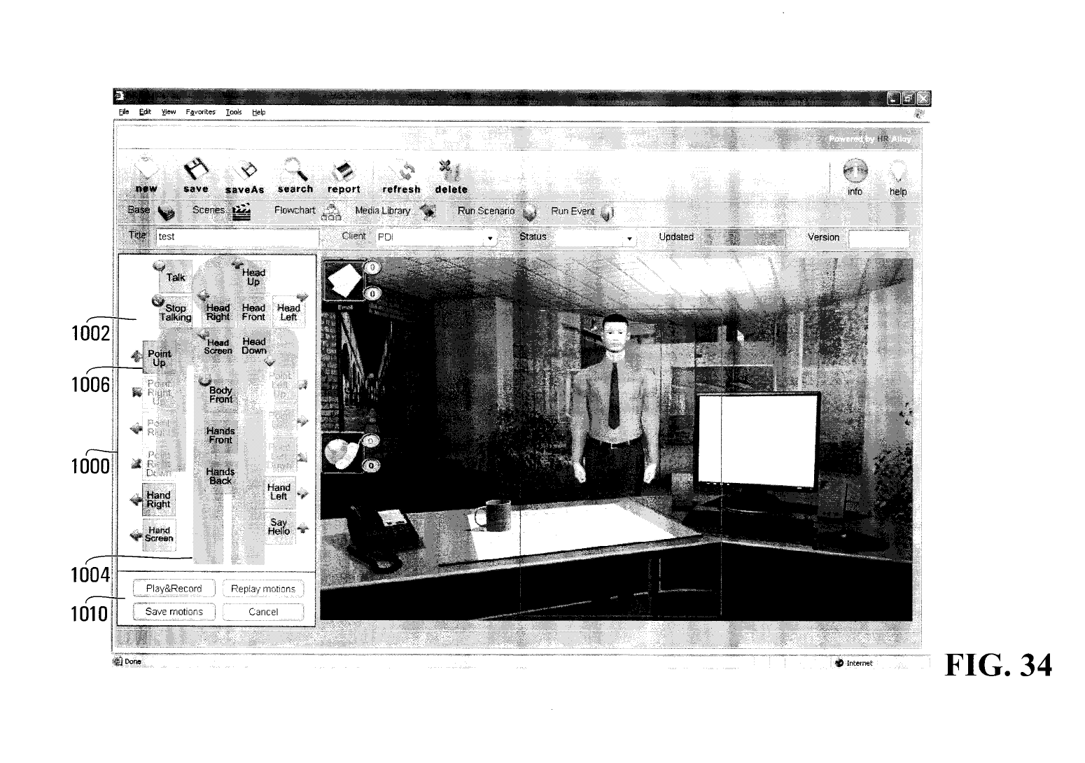

The windows shown in FIGS. 34 to 38 allow defining the behavior of an avatar. In this example, there are two main aspects or properties of the avatar that can be programmed. One is animation and the other is speech.

The animation can be programmed via an animation control area 1000 shown in FIG. 34. The animation control area 1000 shows an animation control interface 1002 allowing the author 19 to specify an initial posture of the avatar as well as the manner the posture will vary throughout the interaction with the candidate 17. The animation control interface 1002 includes a number of possible body movement selections. By “clicking” on one of these options, the movement is automatically built into the virtual simulation such that when the virtual simulation is run the avatar will, at the appropriate time, perforin the desired body movement. To facilitate the selection of the body movements, the animation control interface 1002 provides a visual framework 1004 that mimics the shape of the human body on which are overlaid body movement selection controls 1006. The body movement selection controls 1006 are distributed over the visual framework 1004 according to the body parts to which motion is to be imparted. In other words, the controls 1006 for head movement are located over or adjacent the head part of the visual framework 1004, the controls 1006 for the left hand movement are located over or adjacent the left hand part of the visual framework 1004, etc. This creates an input interface that is very intuitive to use and allows the author 19 to program body movements very quickly and efficiently. In this example, the body movement selection controls 1006 are in the form of boxes with labels therein identifying the movement they produce. Some or all of the boxes are also associated with arrows 1008 that provide additional visual cue about the motion produced.

The lower part of the animation control window 1000 is provided with a set of controls 1010 allowing to play the motions that have been selected so as to see if the desired animation has been produced. When this control is activated, the avatar that appears at the right of the animation control window 1000 performs the body movements in the same fashion as they would appear to the candidate 17 when the virtual simulation is run.

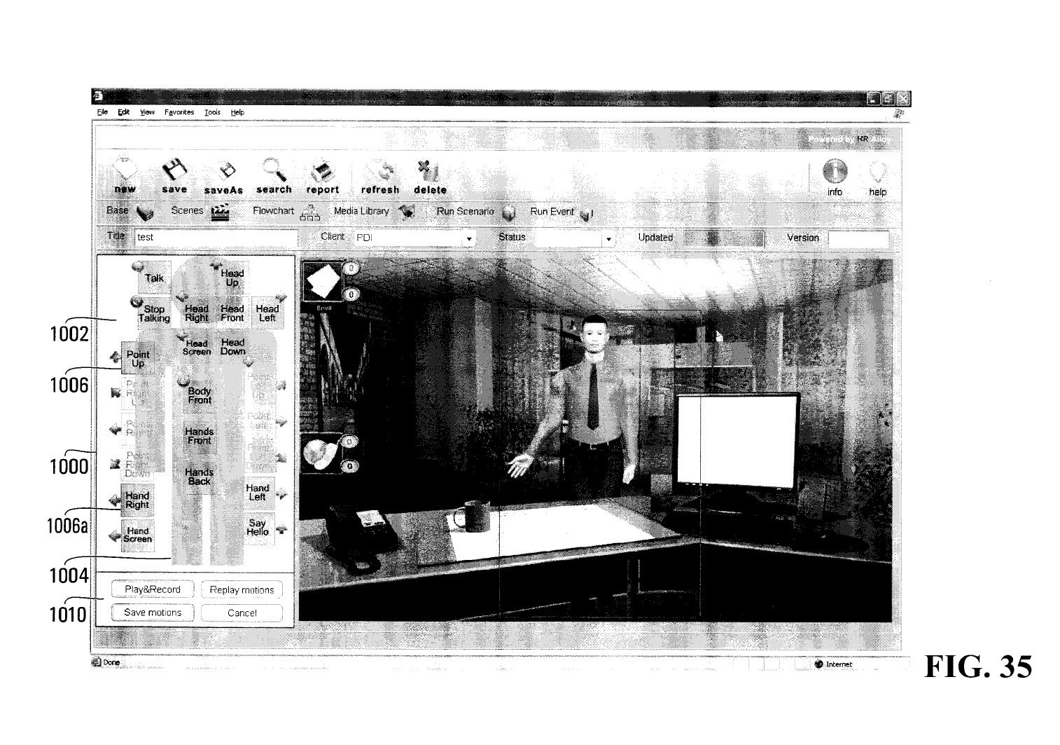

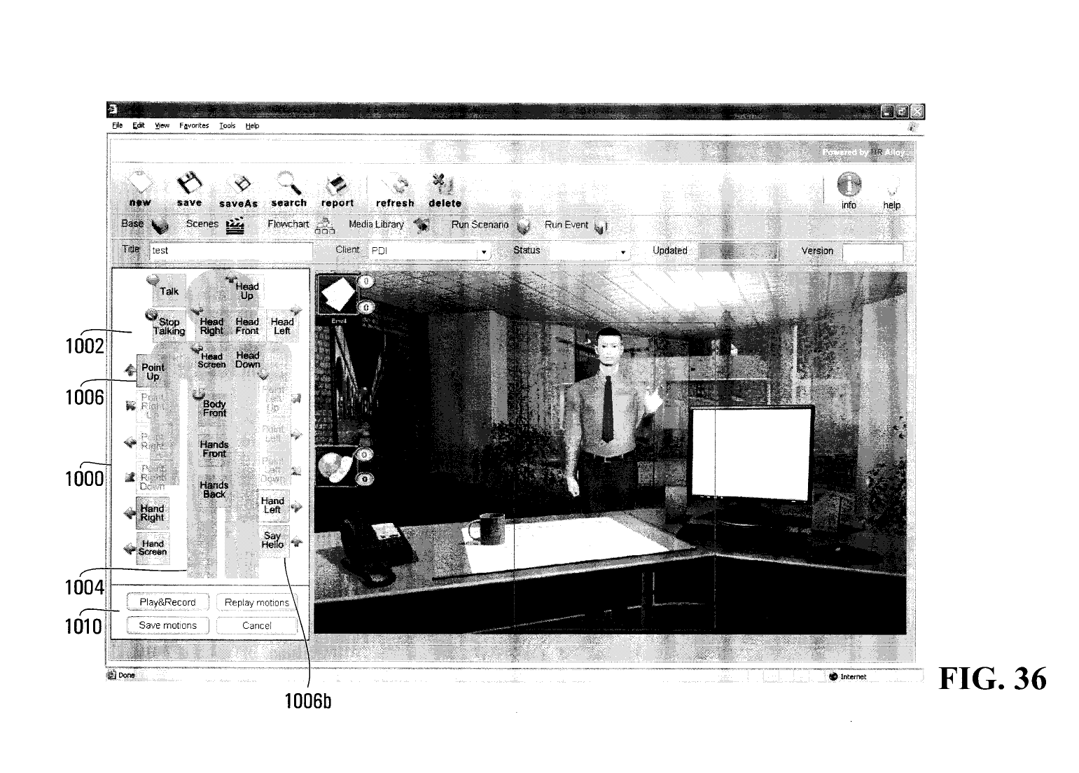

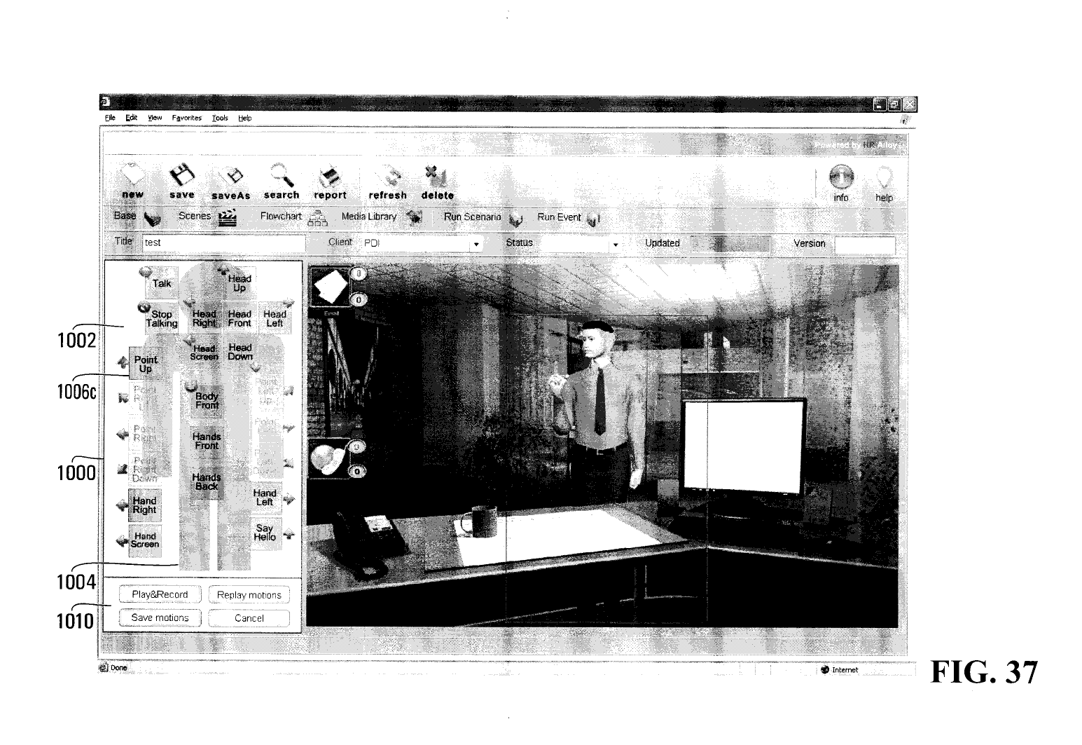

Examples of body movements are shown in the windows of FIGS. 35 to 37. The window shown in FIG. 35 shows the body movement produced when the control 1006a has been selected. The body movement is an extension of the right hand of the avatar. The window shown in FIG. 36 shows a “hello” body movement produced by selecting the control 1006b. Finally, the window shown in FIG. 37 shows a finger pointing body movement produced by selecting the control 1006c.

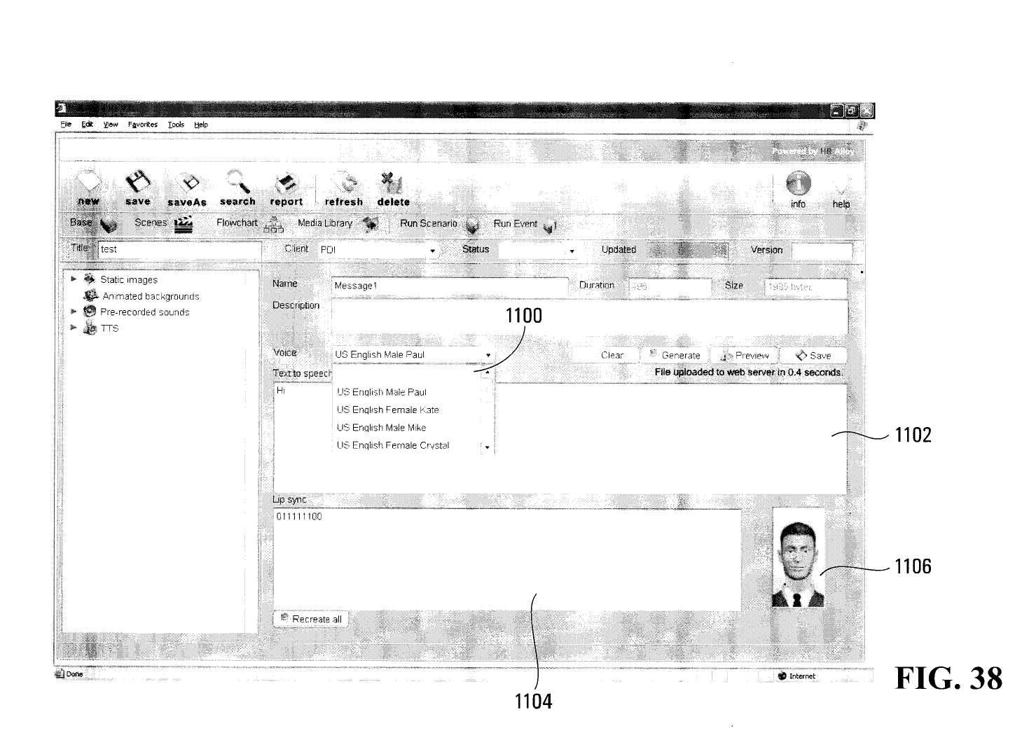

The speech uttered by the avatar can be programmed via the interface shown on the window depicted in FIG. 38. In this example, the interface includes a selection control 1100 allowing determining the characteristic pronunciation of the avatar. Specifically, the control 1100 is in the form of a menu of choices, where different choices correspond to different characteristic pronunciations. For example, characteristic pronunciations in the list can be distinguished on the basis of sex (male, female), social background, and native language, among others.

The window also has an input area 1102 in which the text to be uttered by the avatar can be typed by the author 19. Once the text is input, it is converted to speech by a text-to-speech engine according to the selected characteristic pronunciation. There may be independent text-to-speech engines for each characteristic pronunciation in the list of the control 1100, or a single text-to-speech engine with modifiable parameters according to the characteristic pronunciation that is selected. The text-to-speech engine can be part of the qualification management system server 12 or it may reside in the media server database 44. The output of the text-to-speech engine is an audio file in any appropriate format.

In addition to the audio file, the text-to-speech engine also outputs a lip synchronization code that determines how the avatar will move the lips to provide a realistic talking effect. The lip synchronization code is shown in the area 1104. The code is in the form of a series of ones and zeros, where a zero corresponds to a closed mouth and a one to an opened mouth. The lip synchronization code is derived from the audio file. The text-to-speech engine analyzes the audio file to determine where active speech exists and where silence exists. Specifically, the audio stream is broken into small intervals, say 5 or 20 millisecond intervals. The text-to-speech engine analyses the intervals to determine if they contain active speech or silence. The techniques for performing this analysis are well known in the art and there is no need to describe them in detail. The lip synchronization code is produced by associating a zero to the intervals which contain silence and a one to those containing active speech.

At the right of the area 1104 is provided a pictorial representation 1106 of the avatar's head. The author 19 can play the audio file produced by the text-to-speech engine and at the same time view the lips of the avatar head moving according to the lip synchronization. In this fashion, the author 19 can determine if the desired talking effect has been produced, either from a message point of view or from a visual point of view.

When a virtual simulation is being run, the program logic that manages the simulation is also designed to track the activities of the candidate 17 so as to be able to score or rate the candidate 17 on the basis of its interactions with the simulation. As the virtual simulation is being run, the program logic captures data points that characterize the manner in which the candidate 17 interacts with the simulation, in particular with the interactive objects. The program logic implements a function that uses data points captured during execution of a virtual simulation in order to score or rate the candidate 17. More particularly, the program logic can be designed to track mouse clicks, rollovers, scrolls, typed responses, or other actions of the candidate 17 during the simulation. The measurement may be highly granular, including what the candidate 17 did, when he/she did it, in what order, react times, and who he/she sent things to.

Examples of data points that can be captured during a virtual simulation include:
In connection with an interactive email object
   if email opened
   time email opened
   number of emails opened
   choice of email opened
   if document attached to email was read or not
   if reply, reply to all, forward, cc or bcc was selected
   if subject line changed
   if email closed without action
   if email re-opened
   if email deleted
   if email transferred to folder and in the affirmative which folder
In connection with an interactive instant messenger object
   if instant messenger window closed without action (if reply empty on close)
   if contact added
   if contact deleted
   understanding text message acronyms such as AFK=Away From Keyboard
   interaction between instant messenger and email such as copy and paste messages from one into the other
In connection with an interactive telephone object
   action taken immediately after call (did the candidate open calendar interactive object to enter task or meeting)
   if message was left
   if call was transferred
   where was call transferred
In connection with an interactive question box object
   time at which question was opened
   answers entered by candidate
   if answers were changed during selection
   number of times answers were changed
   if question skipped (viewed but not answered)
In connection with an interactive voice mail object
   time at which voicemail was accessed
   which answer to voicemail was selected
   was message saved
   was message deleted
   was message transferred to another recipients voicemail box
   was contact added
   was contact deleted
   next action taken after call (did the candidate open a calendar interactive object to enter task or meeting immediately after the call)

It will be appreciated that these data points are presented for example purposes and that various other data points may be captured as a virtual simulation is executed.

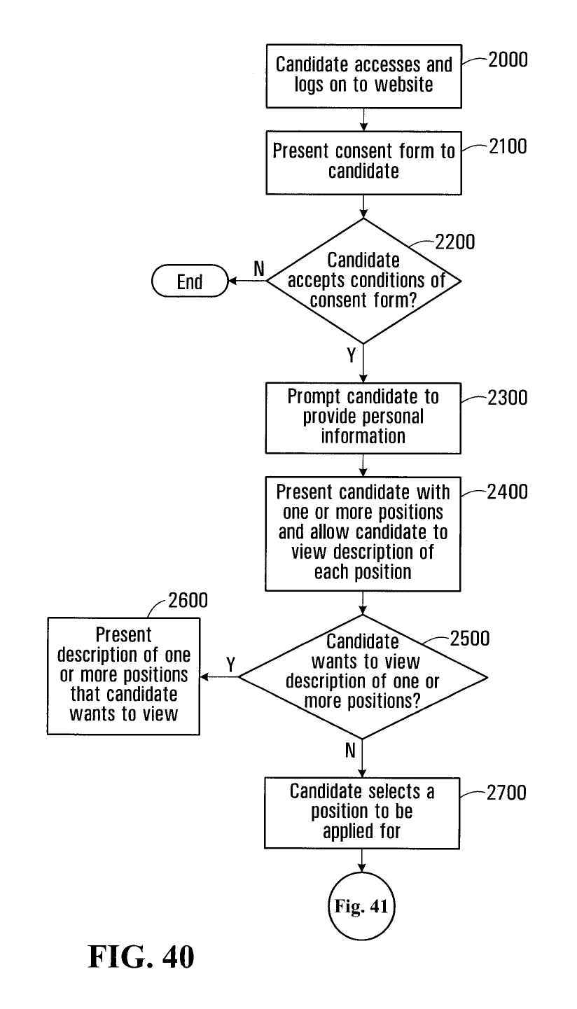

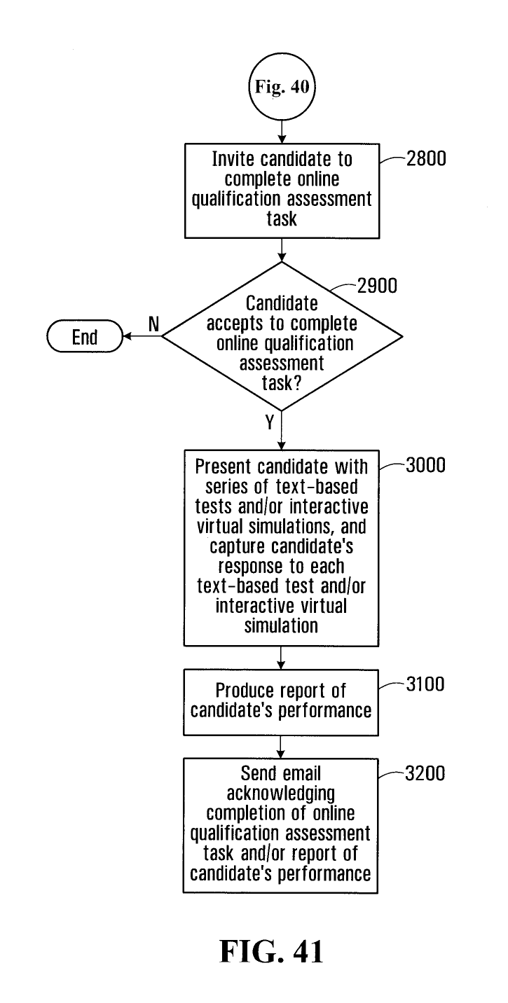

Turning now to FIGS. 40 and 41, there is shown a flow chart describing an example of interaction of the candidate 17 with the qualification management system server 12 over the Internet 14.

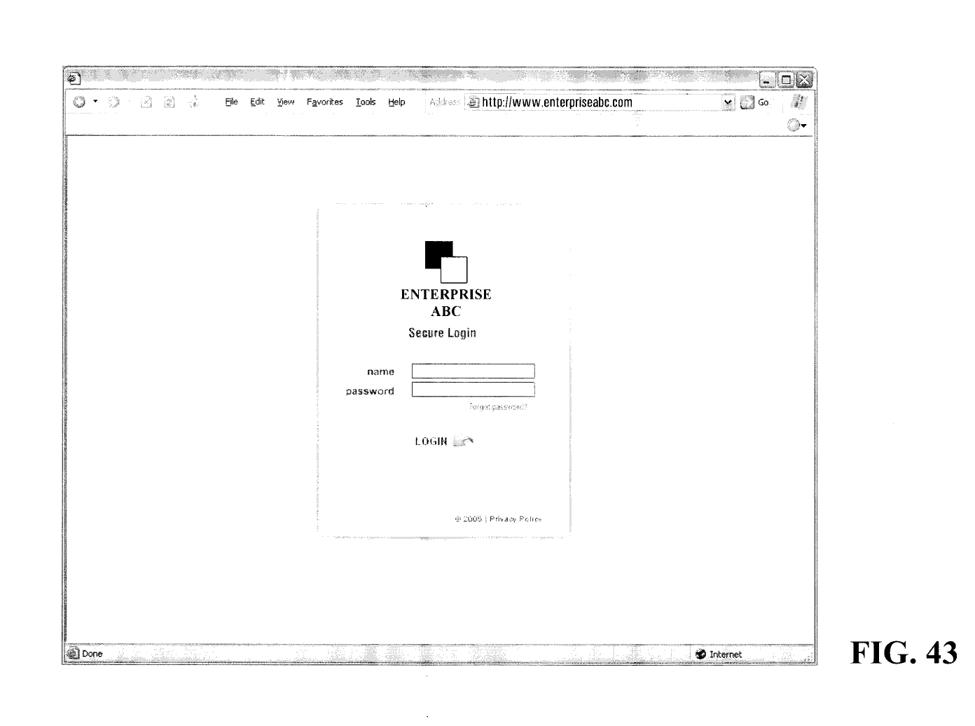

At step 2000, the candidate 17 uses the client computer 10 to access the website implemented by the qualification management system server 12. The candidate 17 logs on to the website by providing identification information (e.g., a special code or personal information such as, for example, his/her name, date of birth, email address) and authentication information (e.g., a password). This login can be effected via a login page provided with various fields in which the candidate 17 can enter the information required to log on to the website. An example of such a login page is shown in FIG. 43.

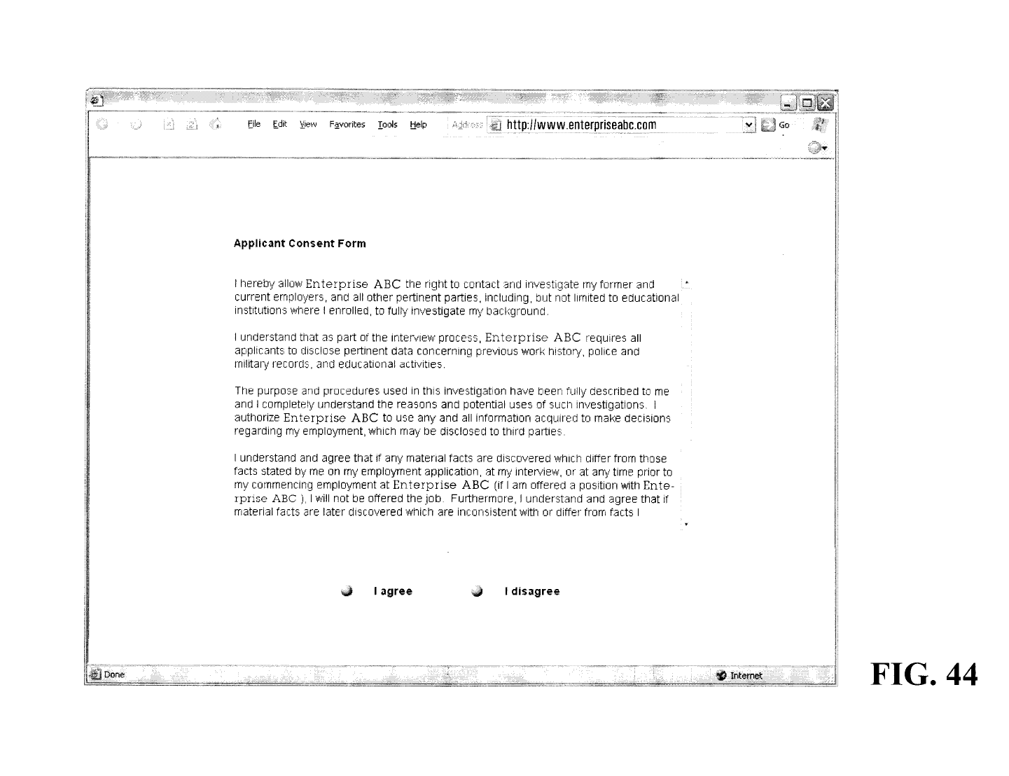

At step 2100, the qualification management system server 12 causes the candidate 17 to be presented with a consent form describing conditions that the candidate 17 can accept or refuse. FIG. 44 shows a window that provides an example of a consent form. In this example, the candidate 17 can indicate his acceptance or refusal of the conditions described in the consent form by selecting an appropriate graphical element indicative of his acceptance or refusal in the lower part of the window.

At step 2200, the qualification management system server 12 determines whether the candidate 17 accepts the conditions of the consent form. If the candidate 17 accepts, the process proceeds to step 2300; otherwise, the process ends and the candidate 17 may receive a message indicating that his/her refusal of the conditions set forth in the consent form is such that the process cannot continue.

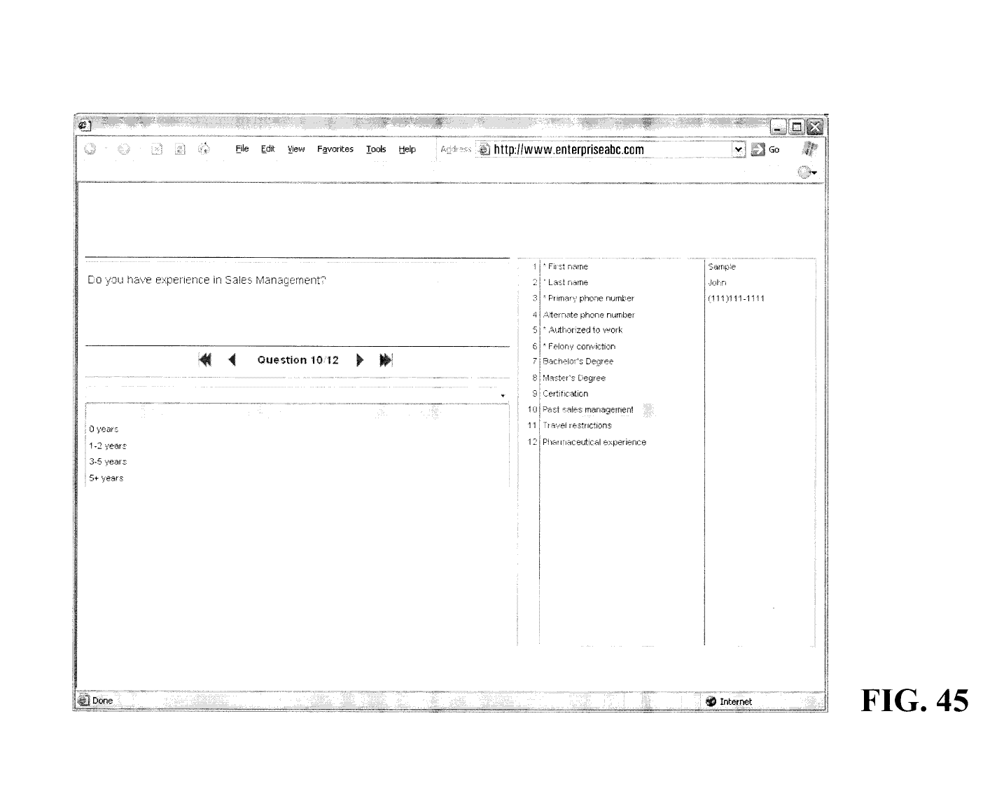

Assuming that the candidate 17 accepts the conditions of the consent form, at step 2300, the qualification management system server 12 causes prompting of the candidate 17 to provide personal information about himself/herself. For example, the candidate 17 may be prompted to provide personal information such as his/her name, contact information (e.g., telephone number, email address, home address), education (e.g., degrees obtained, establishments attended), work experience, work restrictions (e.g., authorization to work in a certain country), or other personal information. This prompting may be effected by presenting a series of questions to the candidate 17 in order to obtain the required personal information. An example of a window prompting the candidate 17 to provide personal information through one of a series of questions is shown in FIG. 45. The qualification management system server 12 creates a record associated with the candidate and includes in that record the personal information provided by the candidate.

At step 2400, the qualification management system server 12 presents to the candidate 17 one or more positions that may be applied for and allows the candidate 17 to view a description of each of these one or more positions. Each description may be presented in the form of a text document and/or a virtual simulation in order to give the candidate 17 a more realistic idea of the corresponding position. For example, the candidate 17 can select a given one of the one or more positions that he/she would like to view a description of by clicking on a graphical element (e.g., a link or button) associated with that position.

At step 2500, the qualification management system server 12 determines whether the candidate desires to view the description of at least one of the one or more positions that may be applied for. If so, the process proceeds to step 2600; otherwise, the process moves to step 2700.

At step 2600, which is performed as a result of the candidate 17 having expressed a desire to view the description of at least one of the one or more positions that may be applied for, the qualification management system server 12 proceeds to present to the candidate 17 the description of each position that he/she desired to view. As mentioned above, the description of a given position may be presented in the form of a text document and/or a virtual simulation.

At step 2700, the candidate 17 selects a position that he/she desires to apply for (hereinafter referred to as “the selected position”) from the one or more positions that may be applied for. For example, the candidate 17 can select the selected position by clicking on a graphical element (e.g., a link or button) associated with that position.

At step 2800, in this example, the qualification management system server 12 proceeds to invite the candidate 17 to complete an online qualification assessment task, which would assist in further assessing his/her suitability for the selected position. This can be effected by displaying a message inviting the candidate 17 to complete the online qualification assessment task.

At step 2900, the qualification management system server 12 determines whether the candidate 17 accepts to complete the online qualification assessment task. If the candidate 17 accepts, the process proceeds to step 3000; otherwise, the process ends and the candidate 17 may receive a message indicating that his/her refusal to complete the online qualification assessment task is such that the process cannot continue.

Assuming that the candidate 17 accepts to complete the online qualification assessment task, at step 3000, the qualification management system server 12 causes the candidate to be presented with a series of text-based tests and/or interactive virtual simulations. An interactive virtual simulation is designed to present information, such as one or more questions or situations, to measure or assess certain predefined qualities of the candidate 17. With each interactive virtual simulation, the candidate 17 is given an opportunity to choose an answer or a course of action in response to each of one or more questions or situations that arises. As the candidate 17 goes through the series of text-based tests and/or interactive virtual simulations, the qualification management system server 12 captures the candidate's response to each text-based test and/or interactive virtual simulation. The scoring function of the qualification management system server 12 uses the captured information in order to score or rate the candidate's performance in completing the online qualification assessment task.

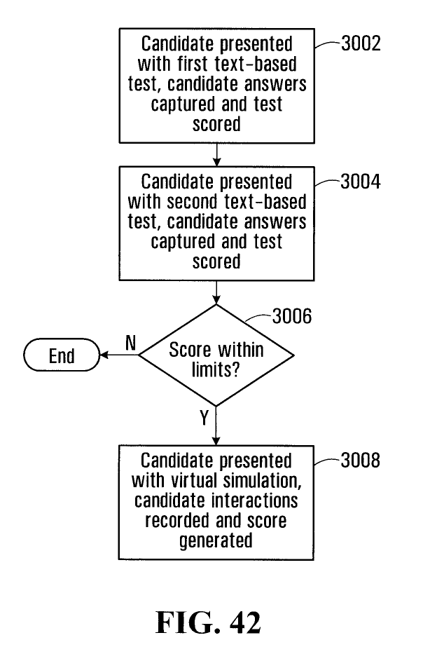

Further detail regarding step 3000 is described with additional reference to an example shown in FIG. 42. Step 3000 is an assessment step where the candidate 17 is assessed to determine if his/her character, behavior, knowledge or experience is suitable for the selected position. In this example, at step 3002, the candidate 17 is presented with a first text-based test and requested to answer questions on that test. For instance, the first text-based test may be a multiple-choice test where each question is provided with a series of possible answers and where the candidate 17 may provide his/her answer to each question by selecting (e.g., by clicking on) one of the possible answers that he/she thinks is the correct answer. As discussed previously, the text-based test is a module 32 associated with a construct 34. The construct 34 includes logic to score responses provided by the candidate 17 according to an interpretation key.

In this example, the process continues at step 3004 where the candidate 17 is presented with a second text-based test. The second text-based test may be of the same type as the first text-based test (e.g., a multiple-choice test) or of a different type. The process performed here is similar to step 3002, where the responses of the candidate 17 to the second text-based test are captured and scored according to an interpretation key.

At step 3006, in this example, it is determined whether the score of the candidate 17 to the second text-based test is acceptable (e.g., within an acceptable range). The rationale for this determination step is that if the score of the candidate 17 is outside a certain range, the candidate 17 is deemed unsuitable for the selected position and there is no point continuing with the assessment any further. Accordingly, if step 3006 is answered in the negative, the process flow branches out, the assessment is terminated, and the candidate 17 may receive a message indicating that the assessment is over. On the other hand, if the candidate's score is within the range considered acceptable, the process continues to step 3008.

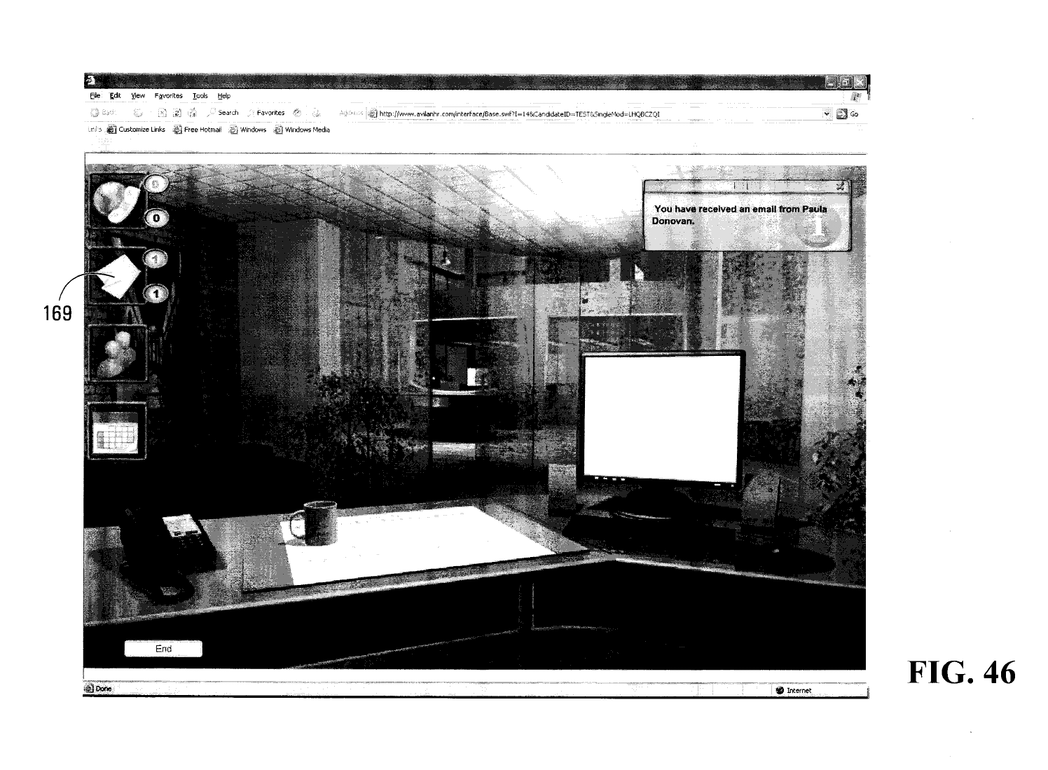

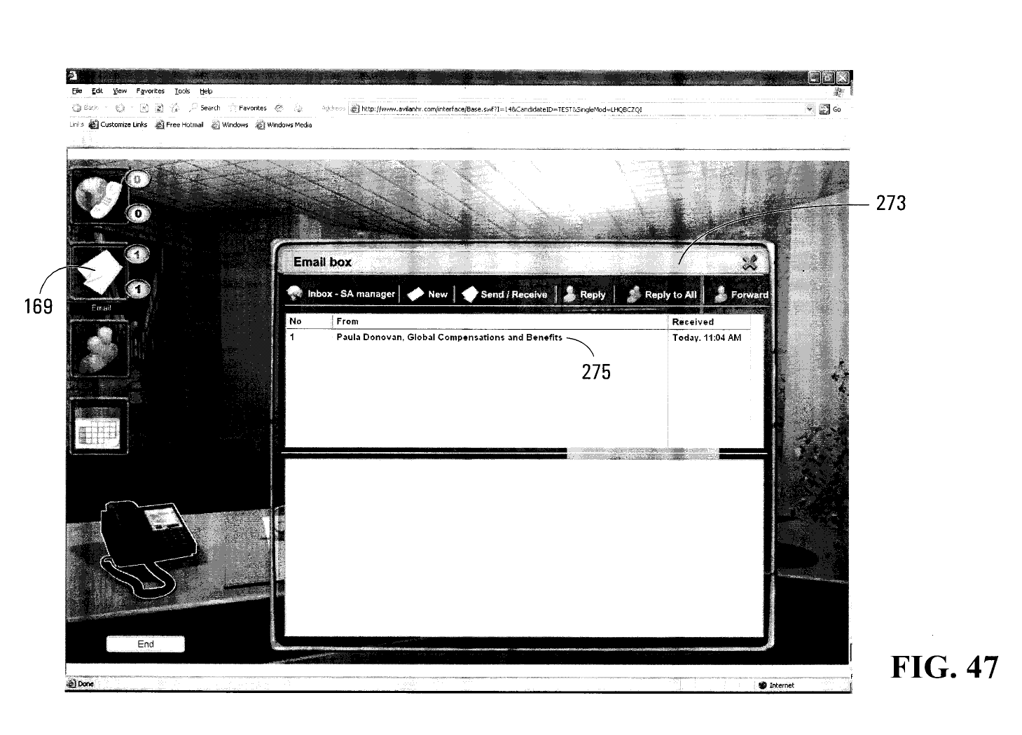

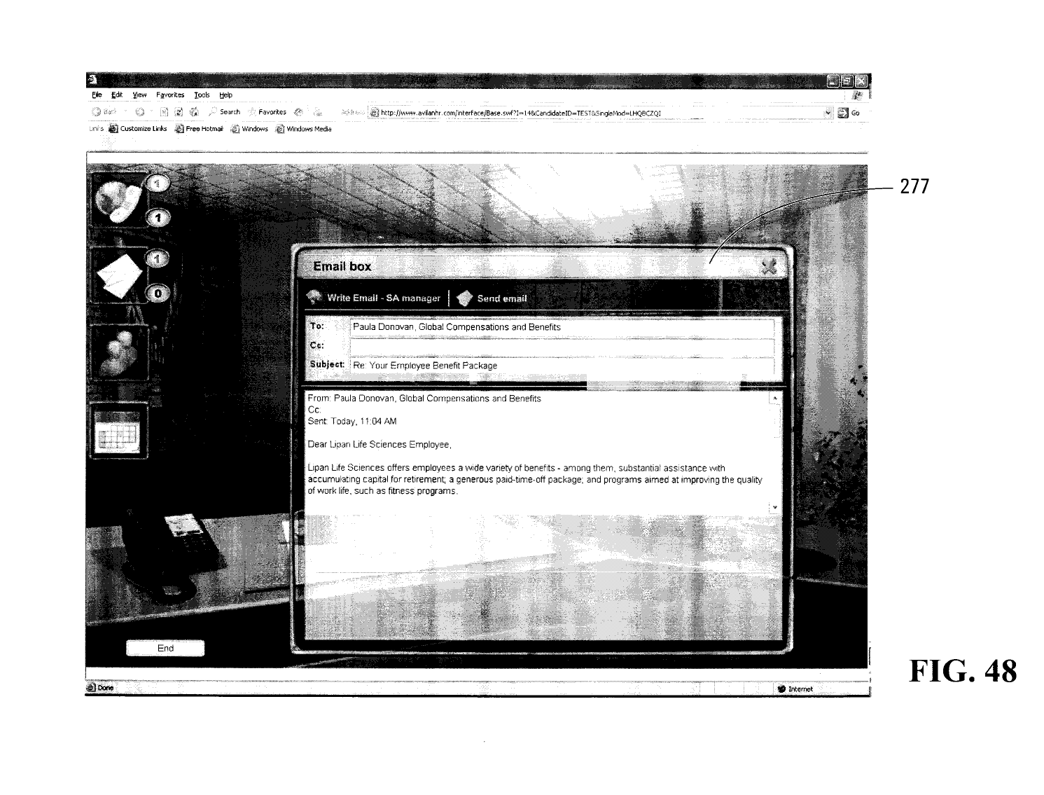

At step 3008, a virtual simulation is presented to the candidate 17. For instance, FIGS. 46 to 53 show windows depicting an example of what the candidate 17 can see on the display of the client computer 10 as the virtual simulation is run. More particularly, in this example, in FIG. 46, the candidate 17 receives an indication that an email has been received. The candidate 17 may in response act (e.g., click) on the email icon 169 in the window in order to cause a window 273 simulating an in-box of an email system to pop up, as shown in FIG. 47. The candidate 17 may then act (e.g., click) on an identifier element 275 in the window 273 that identifies the received email so as to cause display of a window 277 conveying contents of the received email, as shown in FIG. 48.

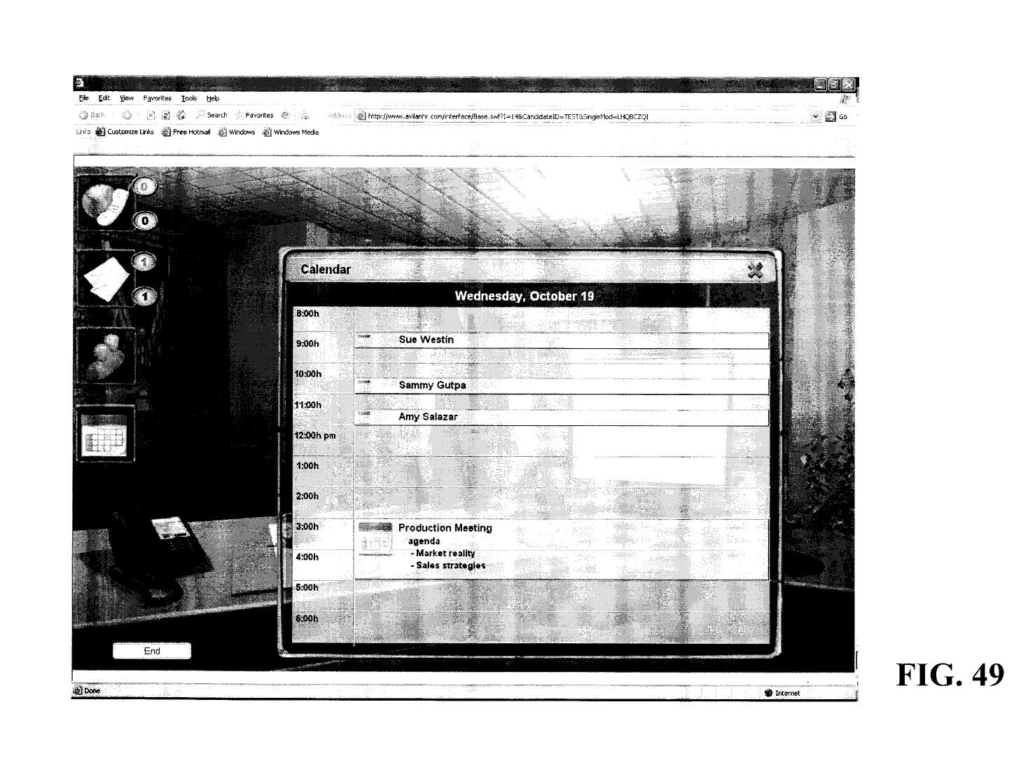

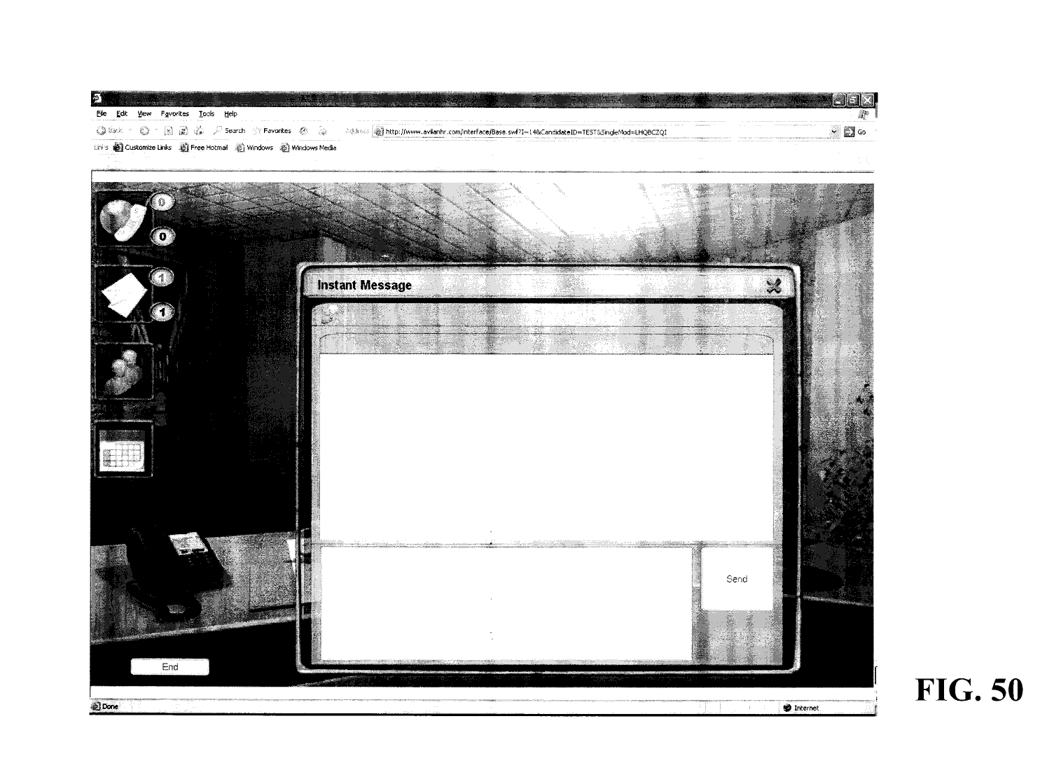

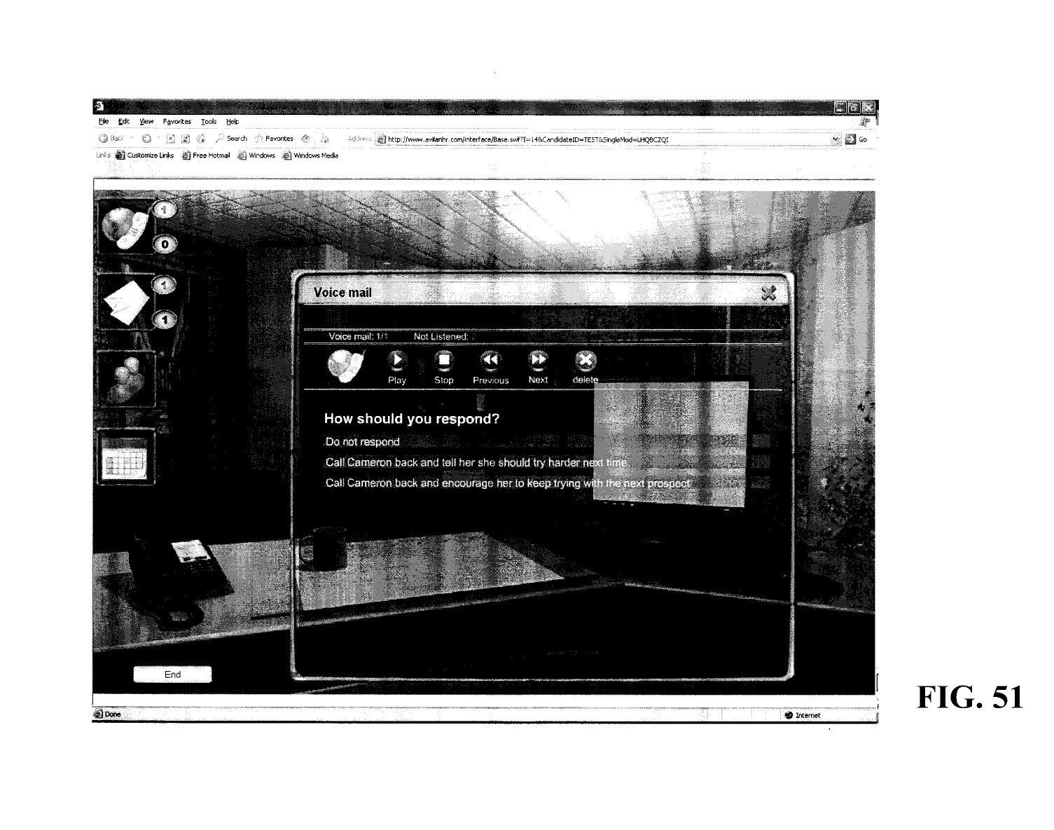

The candidate 17 may interact in a similar manner with other objects during the virtual simulation. For example, FIG. 49 shows an instance where the candidate 17 may interact with an interactive calendar object; FIG. 50 shows an instance where the candidate 17 may interact with an interactive instant message object; and FIG. 51 shows an instance where the candidate 17 may interact with an interactive voice mail object.

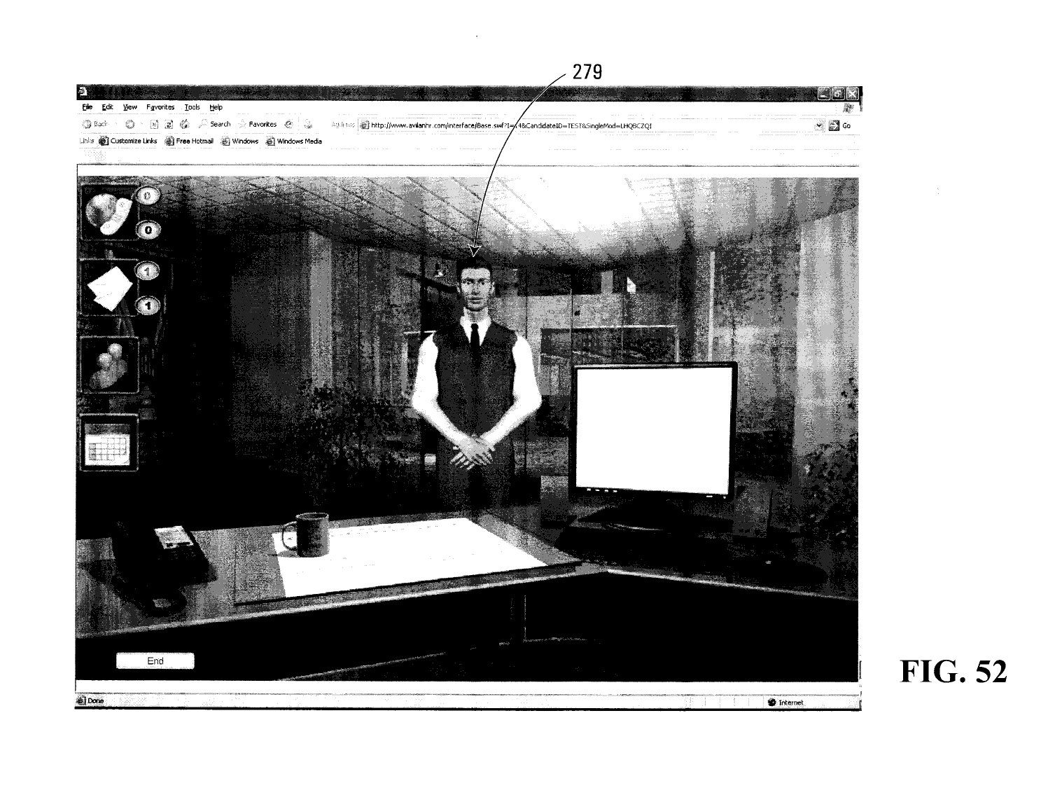

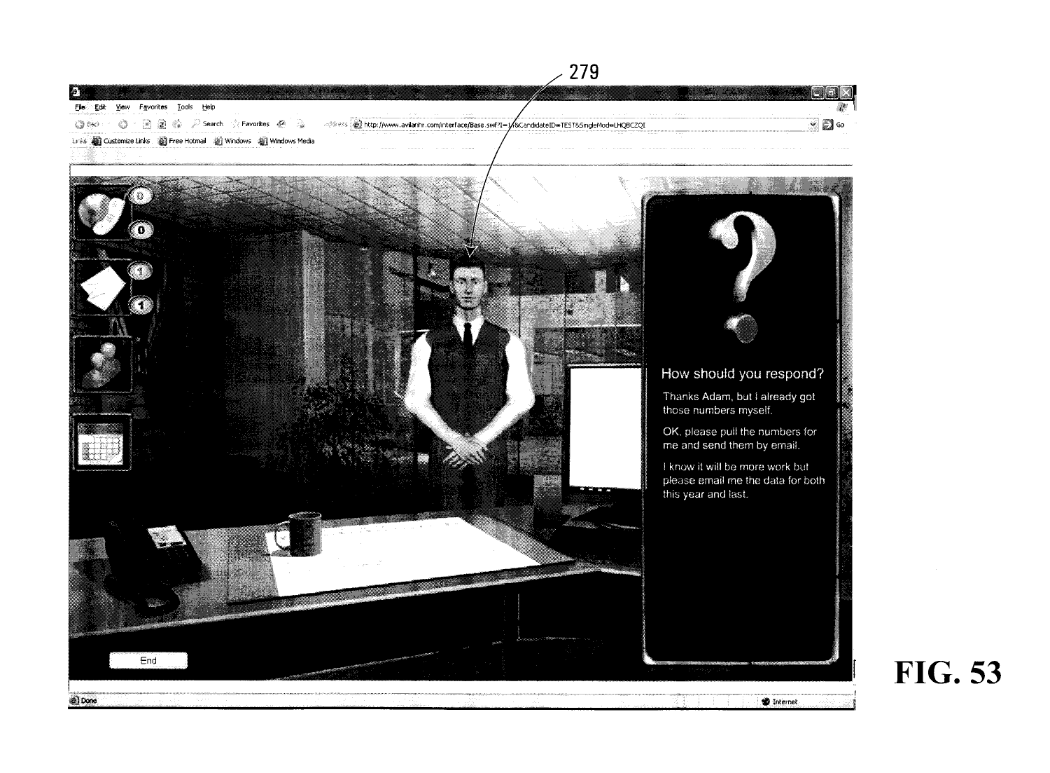

The candidate 17 may also interact with one or more avatars as part of the virtual simulation. For instance, in this example, in FIG. 52, an avatar 279 appears and asks a question to the candidate 17. As shown in FIG. 53, the candidate 17 may then proceed to answer this question, in this case by selecting one of a number of possible answers presented to the candidate 17.

As part of step 3008, actions performed and/or answers provided by the candidate 17 during the virtual simulation are recorded and a score of the candidate's performance is generated.

Continuing with FIG. 41, at step 3100, in this example, on completion of the assessment task by the candidate 17, the qualification management system server 12 produces a report on the candidate's performance using the information captured as part of the series of text-based tests and/or virtual simulations effected in step 3000.

At step 3200, in this example, the qualification management system server 12 sends to the candidate 17 or another party (e.g., a recruiter or potential employer) an email acknowledging the completion of the assessment task and optionally the result given by the scoring function, the report generated at step 3100, or a report derived therefrom. This helps the candidate 17 and/or the other party assess the candidate's suitability for the selected position that has been applied for.

It will be appreciated that, in some embodiments, certain functionality of a given component described herein (including the qualification management system server 12 or part thereof) may be implemented as pre-programmed hardware or firmware elements (e.g., application specific integrated circuits (ASICs), electrically erasable programmable read-only memories (EEPROMs), etc.) or other related elements. In other embodiments, a given component described herein (including the qualification management system server 12 or part thereof) may comprise a processor having access to a code memory which stores program code (instructions) for operation of the processor to implement functionality of that given component. The program code may be stored on a medium which is fixed, tangible, and readable directly by the given component (e.g., removable diskette, CD-ROM, ROM, fixed disk, USB key, etc.). Alternatively, the program code may be stored remotely but transmittable to the given component via a modem or other interface device connected to a network over a transmission medium. The transmission medium may be either a tangible medium (e.g., optical or analog communications lines) or a medium implemented using wireless techniques (e.g., microwave, infrared or other wireless transmission schemes).

It will also be appreciated that, while certain examples of application have been presented, the qualification management system contemplated herein may be used in various applications, including recruiting, promoting, job description simulation, training, and coaching applications.

Although various embodiments have been illustrated, this was for the purpose of describing, but not limiting, the invention. Various modifications will become apparent to those skilled in the art and are within the scope of the invention, which is defined by the attached claims.

1. A computer having a display and a user input device for interacting with a user, the computer executing software for implementing an authoring tool user interface for allowing the user to create a software application executable by a computing entity to implement a qualification management project including a set of modules intended to interact individually with a candidate being assessed by the qualification management project, the authoring tool user interface including a first control allowing the user to select at least some of the modules of the set of modules from a library of modules.

2. A computer as defined in claim 1, wherein the authoring tool user interface includes a second control allowing the user to specify rules which define a sequence in which modules from the set of modules will interact with the candidate during execution of the software application implementing the qualification management project.

3. A computer as defined in claim 1, wherein the qualification management project assesses the candidate for job recruitment purposes.

4. A computer as defined in claim 3, wherein at least one of the modules in the set of modules is a test module for testing the candidate for one or more skills.

5. A computer as defined in claim 4, wherein the test module includes a plurality of questions to which the candidate answers during its interaction with the test module.

6. A computer as defined in claim 4, wherein the test module performs a cognitive assessment procedure on the candidate.

7. A computer as defined in claim 4, wherein the test module performs a personality assessment procedure on the candidate.

8. A computer as defined in claim 3, wherein at least one of the modules in the set of modules includes a welcome message.

9. A computer as defined in claim 3, wherein at least one of the modules in the set of modules includes a message providing instructions to the candidate on how to interact with one or more of the modules.

10. A computer as defined in claim 3, wherein at least one of the modules in the set of modules includes a consent form.

11. A computer as defined in claim 10, wherein the interaction of the candidate with the consent form includes accepting or refusing conditions in the consent form.

12. A computer as defined in claim 3, wherein at least one of the modules in the set of modules is a candidate information form, wherein the candidate interacts with the candidate information form by submitting information selected in the group consisting of candidate name, social security number, position applied for, position title, sex, race/ethnic identification, handicaps and where the candidate heard about the position.

13. A computer as defined in claim 3, wherein at least one of the modules in the set of modules includes a survey to gather an opinion of the candidate.

14. A computer as defined in claim 3, wherein at least one of the modules in the set of modules includes a multi-raters feedback form.

15. A computer as defined in claim 3, wherein at least one of the modules in the set of modules is a virtual simulation module that renders a virtual simulation when the candidate interacts with the virtual simulation module.

16. A computer as defined in claim 15, wherein the virtual simulation module tests the candidate for one or more skills.

17. A computer as defined in claim 2, wherein the second control allows the user to specify rules which define two or more possible sequences in which modules from the set of modules could interact with the candidate during execution of the software application implementing the qualification management project.

18. A computer as defined in claim 17, wherein the second control allows the user to specify rules which consider as a factor inputs made by the user during interaction with one or more modules of the set of modules in selecting the sequence of modules among the two or more possible sequences, according to which the interaction with the candidate with modules of the set of modules is to continue.

19. A computer as defined in claim 1, wherein the authoring tool user interface includes a plurality of control elements associated with respective modules of the set of modules, each control element allowing the user to specify rules that will determine the behaviour of the module during execution of the software application implementing the qualification management project, independently of the behaviour of other modules of the set of modules.

20. A computer as defined in claim 19, wherein at least one of the plurality of control elements includes a library of rules from which the user can chose in specifying the rules that will determine the behaviour of the module associated with the at least one of the plurality of control elements.

21. A computer as defined in claim 20, wherein the at least one of the plurality of control elements includes a programming window in which the user can write one or more rules in programming language.

22. A computer as defined in claim 19, wherein at least one of the modules in the set of modules is a test module for testing the candidate for one or more skills, and wherein a control element of the plurality of control elements associated with the test module includes a library of rules, at least one of the rules implementing a scoring algorithm to score answers of the candidate provided during interaction with the test module.

23. A computer as defined in claim 22, wherein the library of rules of the control element associated with the test module implements a plurality of scoring algorithms from which the user can choose from.

24. A method implemented on a computer having a display and a user input device for interacting with a user, the method comprising:
a. implementing an authoring tool user interface for allowing the user to create a software application executable by a computing entity to implement a qualification management project including a set of modules intended to interact individually with a candidate being assessed by the qualification management project; and
b. providing the authoring tool user interface with a first control allowing the user to select at least some of the modules of the set of modules from a library of modules.

25. A method as defined in claim 24, wherein the authoring tool user interface includes a second control allowing the user to specify rules which define a sequence in which modules from the set of modules will interact with the candidate during execution of the software application implementing the qualification management project.

26. A method as defined in claim 24, wherein the qualification management project assesses the candidate for job recruitment purposes.

27. A method as defined in claim 26, wherein at least one of the modules in the set of modules is a test module for testing the candidate for one or more skills.

28. A method as defined in claim 27, wherein the test module includes a plurality of questions to which the candidate answers during its interaction with the test module.

29. A method as defined in claim 27, wherein the test module performs a cognitive assessment procedure on the candidate.

30. A method as defined in claim 27, wherein the test module performs a personality assessment procedure on the candidate.

31. A method as defined in claim 26, wherein at least one of the modules in the set of modules includes a welcome message.

32. A method as defined in claim 26, wherein at least one of the modules in the set of modules includes a message providing instructions to the candidate on how to interact with one or more of the modules.

33. A method as defined in claim 26, wherein at least one of the modules in the set of modules includes a consent form.

34. A method as defined in claim 33, wherein the interaction of the candidate with the consent form includes accepting or refusing conditions in the consent form.

35. A method as defined in claim 26, wherein at least one of the modules in the set of modules is a candidate information form, wherein the candidate interacts with the candidate information form by submitting information selected in the group consisting of candidate name, social security number, position applied for, position title, sex, race/ethnic identification, handicaps and where the candidate heard about the position.

36. A method as defined in claim 26, wherein at least one of the modules in the set of modules includes a survey to gather an opinion of the candidate.

37. A method as defined in claim 26, wherein at least one of the modules in the set of modules includes a multi-raters feedback form.

38. A method as defined in claim 26, wherein at least one of the modules in the set of modules is a virtual simulation module that renders a virtual simulation when the candidate interacts with the virtual simulation module.

39. A method as defined in claim 26, wherein the virtual simulation module tests the candidate for one or more skills.

40. A method as defined in claim 25, wherein the second control allows the user to specify rules which define two or more possible sequences in which modules from the set of modules could interact with the candidate during execution of the software application implementing the qualification management project.

41. A method as defined in claim 40, wherein the second control allows the user to specify rules which consider as a factor inputs made by the user during interaction with one or more modules of the set of modules in selecting the sequence of modules among the two or more possible sequences, according to which the interaction with the candidate with modules of the set of modules is to continue.

42. A method as defined in claim 24, wherein the authoring tool user interface includes a plurality of control elements associated with respective modules of the set of modules, each control element allowing the user to specify rules that will determine the behaviour of the module during execution of the software application implementing the qualification management project, independently of the behaviour of other modules of the set of modules.

43. A method as defined in claim 42, wherein at least one of the plurality of control elements includes a library of rules from which the user can chose in specifying the rules that will determine the behaviour of the module associated with the at least one of the plurality of control elements.

44. A method as defined in claim 43, wherein the at least one of the plurality of control elements includes a programming window in which the user can write one or more rules in programming language.

45. A method as defined in claim 42, wherein at least one of the modules in the set of modules is a test module for testing the candidate for one or more skills, and wherein a control element of the plurality of control elements associated with the test module includes a library of rules, at least one of the rules implementing a scoring algorithm to score answers of the candidate provided during interaction with the test module.

46. A method as defined in claim 45, wherein the library of rules of the control element associated with the test module implements a plurality of scoring algorithms from which the user can choose from.

47-75. (canceled)

76. A computer readable storage medium containing program code for execution by a computing entity to implement an authoring tool, the authoring tool allowing a user to create a software application executable to implement a qualification management project including a set of modules intended to interact individually with a candidate being assessed by the qualification management project, the program code comprising a component to implement an authoring tool user interface that includes a first control allowing the user to select at least some of the modules of the set of modules from a library of modules.

77. A computer readable storage medium as defined in claim 76, wherein the authoring tool user interface includes a second control allowing the user to specify rules which define a sequence in which modules from the set of modules will interact with the candidate during execution of the software application implementing the qualification management project.

78. A computer readable storage medium as defined in claim 76, wherein the qualification management project assesses the candidate for job recruitment purposes.

79. A computer readable storage medium as defined in claim 78, wherein at least one of the modules in the set of modules is a test module for testing the candidate for one or more skills.

80. A computer readable storage medium as defined in claim 79, wherein the test module includes a plurality of questions to which the candidate answers during its interaction with the test module.

81. A computer readable storage medium as defined in claim 79, wherein the test module performs a cognitive assessment procedure on the candidate.

82. A computer readable storage medium as defined in claim 79, wherein the test module performs a personality assessment procedure on the candidate.

83. A computer readable storage medium as defined in claim 78, wherein at least one of the modules in the set of modules includes a welcome message.

84. A computer readable storage medium as defined in claim 78, wherein at least one of the modules in the set of modules includes a message providing instructions to the candidate on how to interact with one or more of the modules.

85. A computer readable storage medium as defined in claim 78, wherein at least one of the modules in the set of modules includes a consent form.

86. A computer readable storage medium as defined in claim 85, wherein the interaction of the candidate with the consent form includes accepting or by refusing conditions in the consent form.

87. A computer readable storage medium as defined in claim 78, wherein at least one of the modules in the set of modules is a candidate information form, wherein the candidate interacts with the candidate information form by submitting information selected in the group consisting of candidate name, social security number, position applied for, position title, sex, race/ethnic identification, handicaps and where the candidate heard about the position.

88. A computer readable storage medium as defined in claim 78, wherein at least one of the modules in the set of modules includes a survey to gather an opinion of the candidate.

89. A computer readable storage medium as defined in claim 78, wherein at least one of the modules in the set of modules includes a multi-raters feedback form.

90. A computer readable storage medium as defined in claim 78, wherein at least one of the modules in the set of modules is a virtual simulation module that renders a virtual simulation when the candidate interacts with the virtual simulation module.

91. A computer readable storage medium as defined in claim 90, wherein the virtual simulation module tests the candidate for one or more skills.

92. A computer readable storage medium as defined in claim 77, wherein the second control allows the user to specify rules which define two or more possible sequences in which modules from the set of modules could interact with the candidate during execution of the software application implementing the qualification management project.

93. A computer readable storage medium as defined in claim 92, wherein the second control allows the user to specify rules which consider as a factor inputs made by the user during interaction with one or more modules of the set of modules in selecting the sequence of modules among the two or more possible sequences, according to which the interaction with the candidate with modules of the set of modules is to continue.

94. A computer readable storage medium as defined in claim 76, wherein the authoring tool user interface includes a plurality of control elements associated with respective modules of the set of modules, each control element allowing the user to specify rules that will determine the behaviour of the module during execution of the software application implementing the qualification management project, independently of the behaviour of other modules of the set of modules.

95-102. (canceled)

103. A computer having a display and a user input device for interacting with a candidate, the computer:
a. being responsive to signals sent from a computing entity at a remote location over a data network for implementing a user interface of a qualification management project for assessing the candidate, the qualification management project including a set of modules intended to interact individually with the candidate via the user interface;
b. executing software to:
i. sense candidate inputs at the user input device;
ii. generate signals conveying information describing the candidate inputs;
iii. sending the signals conveying the information describing the candidate inputs to the computing entity at the remote location over the data network, the computing entity including logic rules which determine a sequence in which modules from the set of modules will interact with the candidate, the logic rules using as a factor the candidate inputs in determining the sequence; and
c. being responsive to signals from the computing entity sent over the data network to allow the candidate to interact with the modules according to the determined sequence.

104-125. (canceled)
